(19) United States
(12) Patent Application Publication
(10) Pub. No.: US 2017/0264822 A1
(43) Pub. Date: Sep. 14, 2017

(54) Mounting Device for Portable Multi-Stream Video Recording Device

(71) Applicant: Waylens, Inc., Boston, MA (US)

(72) Inventors: Dawei Shen, Brookline, MA (US); Haowei Zhang, Wayland, MA (US); Huifeng Jiang, Shanghai (CN); Zhongju Li, Shanghai (CN); Linlin Song, Shanghai (CN)

(21) Appl. No.: 15/609,542

(22) Filed: May 31, 2017

Related U.S. Application Data
(63) Continuation of application No. 15/044,404, filed on Feb. 16, 2016.
(60) Provisional application No. 62/116,281, filed on Feb. 13, 2015.

(51) Int. Cl. H04N 5/232; H04N 5/225; G11B 27/031

(52) U.S. Cl. CPC H04N 5/23238; G11B 27/031; H04N 5/2252; H04N 5/2257; H04N 5/23203

(57) ABSTRACT

A disclosed mounting device for a portable video capture device includes a main body, a first coupling device, and a second coupling device. The main body includes a Global Positioning System (GPS) receiver. The first coupling device provides a mechanical coupling between the main body and a mounting surface, and the second coupling device provides an electrical and mechanical coupling between the main body and the portable video capture device. The GPS receiver includes a GPS antenna and a GPS module. The GPS module includes circuitry that receives GPS signals from the GPS antenna and provides the received GPS signals to the portable video capture device through the electrical coupling provided by the second coupling device. A disclosed method includes generating, from the GPS signals, position information that is updated at a rate of no less than 6 Hz, and transmitting the position information to the portable video capture device.

### CROSS REFERENCE TO RELATED APPLICATION

This disclosure claims the benefit of priority to U.S. patent application Ser. No. 15/044,404, filed Feb. 16, 2016, the disclosure of which is incorporated by reference herein.

### FIELD

This disclosure generally relates to portable image and video capturing devices.

### BACKGROUND

Portable video capture devices are used in automobiles to capture and document driving experiences. Such devices are especially important for law enforcement purposes. Conventional camera systems generate large amounts of data that must be transferred to a computing device (e.g., laptop computer, smart phone, etc.) before it can be viewed. The transfer of data may occur over a slow connection and may therefore be time consuming and cumbersome. Further, it may be difficult to encode other relevant data (e.g., driving conditions, engine performance parameters, etc.) along with the captured video data to aid in subsequent analysis of captured video data. As such, there is a need for improvements in the field of portable image and video capture devices that are used in automotive applications.

### SUMMARY

The disclosed systems, methods, and computer program products, overcome the above-described shortcomings of conventional portable video capture devices and enable quick and streamlined viewing, highlighting, indexing, and editing of video data captured by a portable video capture device mounted in an automobile. The disclosed systems also enable real-time encoding of engine performance data and driving condition data along with captured video data that may be presented as a visual display superimposed on the video data. The disclosed systems may further include at least one of a Global Positioning System (GPS) receiver, an accelerometer, a pitch/roll sensor, and an altimeter, which generate(s) corresponding position data, that may be displayed along with video data.

A disclosed mounting device for a portable video capture device includes a main body, a first coupling device, and a second coupling device. The main body includes a Global Positioning System (GPS) receiver. The first coupling device provides a mechanical coupling between the main body and a mounting surface, and the second coupling device provides an electrical and mechanical coupling between the main body and the portable video capture device. The GPS receiver includes a GPS antenna and a GPS module. The GPS module includes circuitry that receives GPS signals from the GPS antenna and provides the received GPS signals to the portable video capture device through the electrical coupling provided by the second coupling device.

A disclosed method includes receiving GPS signals by the GPS antenna and processing the received GPS signals by a processor circuit in the GPS module. The method further includes transmitting the processed GPS signals to the portable video capture device through the electrical coupling between the main body of the mounting device and the portable video capture device provided by the second coupling device. The disclosed method further includes generating, from the GPS signals, position information that is updated at a rate of no less than 6 Hz, and transmitting the position information to the portable video capture device.

Computer program products are also disclosed, that include a non-transitory computer readable storage device. The non-transitory transitory computer readable storage device includes computer program instructions stored thereon that, when executed by a processor, cause the processor to control circuitry in a mounting device for a portable video capture device. For example, when executing the computer program instructions, a processor may perform operations including: receiving GPS signals from the GPS antenna, processing the received GPS signals, and transmitting the processed GPS signals to the portable video capture device.

The above summary may present a simplified overview of some embodiments of the invention to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

Further embodiments, features, and advantages, as well as the structure and operation of the various embodiments, are described in detail below with reference to the accompanying drawings.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, explain the embodiments of the invention. In the drawings, like reference numbers generally indicate identical, functionally similar, and/or structurally similar elements.

FIG. 1 is an architectural diagram of an example connected camera system, according to an embodiment.

FIG. 2 illustrates a three-dimensional view of a portable video capture device, according to an embodiment.

FIG. 3 illustrates a view of the portable video capture device of FIG. 2 illustrating a rearward facing end of the portable video capture device, according to an embodiment.

FIG. 4A is a three-dimensional view of the portable video capture device of FIGS. 2 and 3 with a coordinate system used to define a cross-section view in FIG. 4B according to an embodiment.

FIG. 4B is a cross sectional view of the portable video capture device of FIGS. 2, 3, and 4A, according to an embodiment.

FIG. 5 illustrates components of the portable video capture device of FIGS. 2, 3, and 4A, according to an embodiment.

FIG. 6 is a schematic illustration of the portable video capture device configured to interact with several external devices, according to an embodiment.

FIG. 7A illustrates a first snapshot of video data captured by the portable video capture device along with data from various sensors shown as a visual display superimposed on video data, according to an embodiment.

FIG. 7B illustrates a second snapshot of video data captured by the portable video capture device along with data from various sensors shown as a visual display superimposed on video data, according to an embodiment.

FIG. 8 illustrates a third snapshot of video data captured by the portable video capture device 110, according to an embodiment.

FIG. 9 is flowchart illustrating an example method of configuring a portable video capture device to enable Smart WiFi connectivity, according to an embodiment.

FIG. 10A illustrates a first example mobile application user interface showing a home selection screen of a video editing interface, according to an embodiment.

FIG. 10B illustrates a mobile application user interface showing a video editing screen of the video editing interface that is initiated from the home selection screen of FIG. 10A, according to an embodiment.

FIG. 11A illustrates a second example mobile application user interface showing a home selection screen of a video editing interface, according to an embodiment.

FIG. 11B illustrates a mobile application user interface showing a video editing screen of the video editing interface that is initiated from the home selection screen of FIG. 10A, according to an embodiment.

FIG. 12A illustrates a mobile application user interface showing a video editing screen that allows a user to select a portion of video for editing based on a touch input gesture in the form of a scrolling motion, according to an embodiment.

FIG. 12B illustrates a mobile application user interface showing a video editing screen that allows a user to further refine the video portion selected in the screen of FIG. 12A, according to an embodiment.

FIG. 13 is a schematic illustration of the portable video capture device coupled to a mounting device, according to an embodiment.

FIG. 14 is a schematic illustration of the portable video capture device and the mounting device illustrating details of an electrical and mechanical coupling, according to an embodiment.

FIG. 15 is a schematic illustration of the mounting device including a power source connector, according to an embodiment.

FIG. 16 is a flowchart illustrating a method of operating a mounting device for a portable video capture device, according to an embodiment.

FIG. 17 is a block diagram illustrating an example computer-based system that may be used to control a camera system, according to an embodiment.

FIG. 18 illustrates an example computer network environment in which an embodiment may be implemented.

### DETAILED DESCRIPTION

This disclosure provides systems, methods, and computer program products that provide quick and streamlined viewing, highlighting, indexing, and editing of video data captured by a portable video capture device mounted in an automobile. The disclosed systems also enable real-time encoding of additional data (e.g., engine performance data and driving condition data) that may be presented as a visual display of the additional data superimposed on the video data.

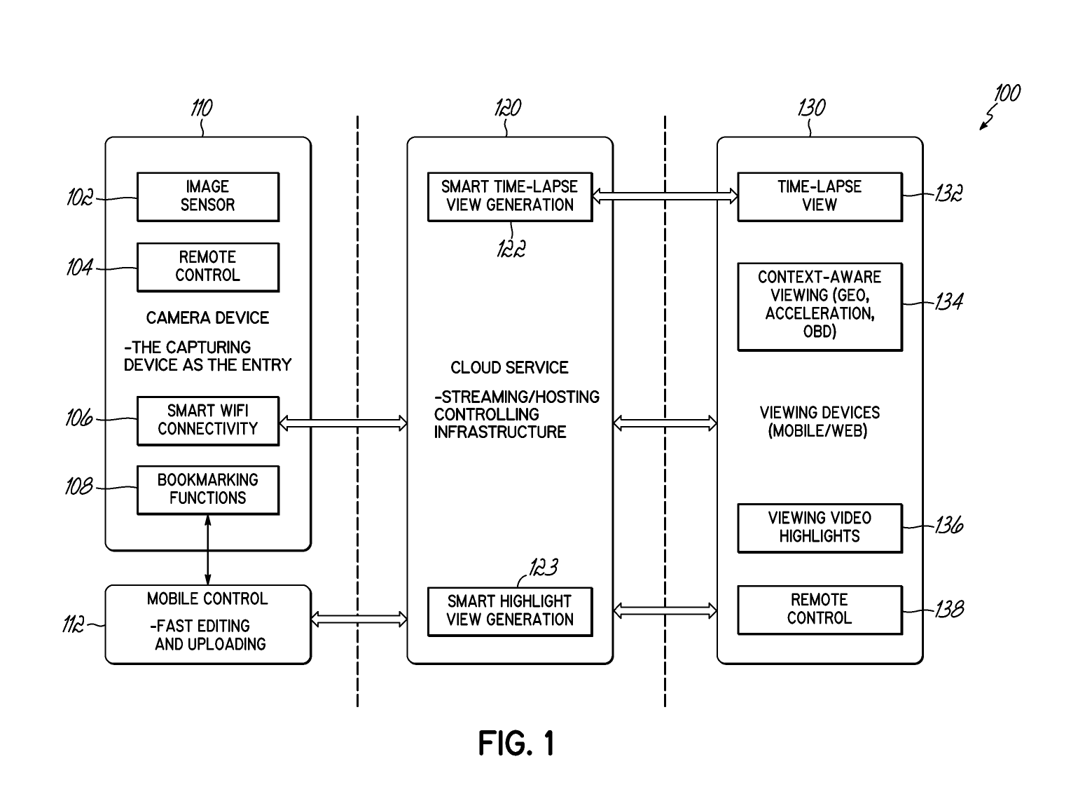

FIG. 1 is an architectural diagram of an example connected camera system 100, according to an embodiment. In this example, the connected camera system 100 is organized into four system architecture components, a portable video capture device 110, a cloud server 120, viewing devices 130 (which communicate with the portable video capture device 110 via the cloud service 120), and a controlling mobile device 112 (which directly communicates with the portable video capture device 110 via a Smart WiFi connection 106). Note that the same mobile device 112 may serve as both a controlling device and a viewing device (of 130).

The portable video capture device 110 is configured with an image sensor 102 (including camera hardware, such as a lens and sensor) for capturing and displaying visual data. The portable video capture device 110 is further configured with a (dedicated) remote control interface 104 that may be used to control the image sensor 110 via a remote-control device, as described in greater detail below. The mobile control interface 112 may enable a user to control the portable video capture device 110 with direct WiFi communications, as described in greater detail below. The portable video capture device 110 further includes bookmarking functions 108 for marking or highlighting segments of the captured visual data, as displayed on the image sensor 110. The portable video capture device 110 enables users to use the controlling mobile device 112 to perform the marking/highlighting functions 108.

The Smart WiFi connectivity 106 is a communication interface used to communicate data between the portable video capture device 110 and the cloud service 120, and between the cloud service 120 and the viewing devices 130. For example, the Smart WiFi connectivity 106 may transmit (e.g., stream) captured visual data to viewing devices 130. The Smart WiFi connectivity 106 may also receive control commands from the viewing devices 130 and/or the mobile controlling device 112. The control commands may provide control instructions to the portable video capture device 110,

The cloud service 120 may include a streaming, hosting, and controlling infrastructure for the connected camera system 100. The cloud service 120 provides a viewing, controlling, and editing experience, of visual data captured by the portable video capture device 110, to viewing devices 130 (e.g., mobile phone, web browsers, etc.). The cloud service 120 may include hardware and software modules that automatically generate special views of captured video data. For example, the cloud service 120 may generate 122 time-lapse views 132 that may be provided to end-users via the viewing devices 130. Further, the cloud service 120 may generate 123 smart highlighted 136 portions of video data that may be provided to end-users via the viewing devices 130.

The viewing experiences provided to viewing devices 130 may further include context-aware viewing 134. For example, various data from position, acceleration, OBD, sensors, etc., may be displayed by viewing devices 130 as a visual display superimposed on video data. Viewing devices 130 may further include a remote-control interface 138 for controlling the portable video capture device 110 via the portable video capture device 110 interface 104.

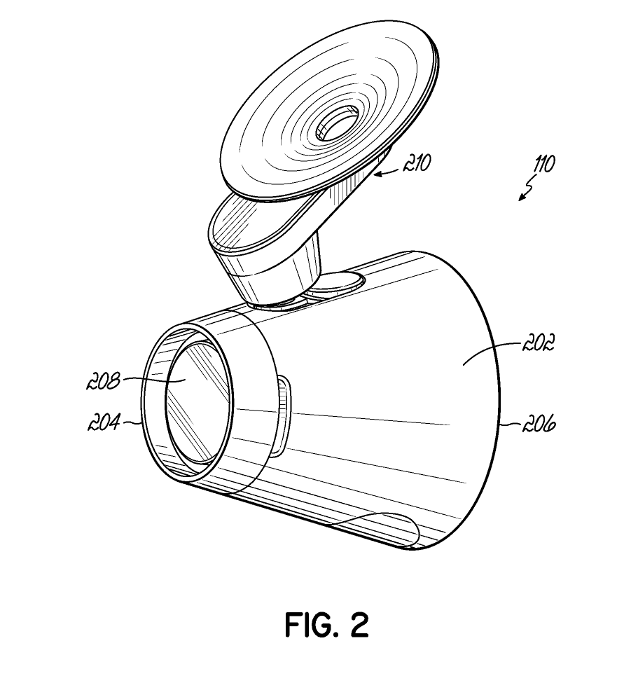

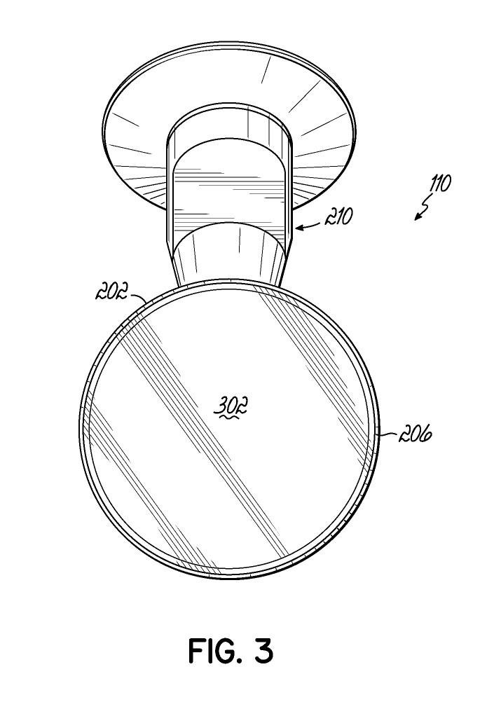

FIG. 2 illustrates a three-dimensional view of a portable video capture device 110, according to an embodiment. In this example, the portable video capture device 110 has a conically-shaped body 202 with a forward-facing end 204 and a rearward-facing end 206. The portable video capture device 110 may be constructed of any suitable materials (e.g., metal, plastic, glass, etc.) as known in the subject art. The forward-facing end 204 includes a lens 208 that captures image light. As described in greater detail below, the rearward facing end 206 includes a visual display (shown below in FIG. 3). The portable video capture device 110 further includes a mounting device 210 that enables the portable video capture device 110 to be mounted to an automobile windshield. In this configuration, the portable video capture device 110 captures video data from image light entering the lens 208 and provides a video record of a forward-looking view a driving experience.

FIG. 3 illustrates a view of the portable video capture device 110 of FIG. 2 that includes the rearward-facing end 206 of the portable video capture device 110, in accordance with an embodiment. This view provides an illustration of the way the portable video capture device 110 of FIG. 2 may appear to a driver of an automobile when the portable video capture device 110 is mounted on an automobile windshield. The rearward facing end 206 has a visual display screen 302. FIG. 3 also includes a further view of the mounting device 210 which may enable mounting the portable video capture device 110 to an automobile windshield.

In an example embodiment, the screen is circular and has 1.3-inch diameter. The display 302 includes an active-magnetic organic light-emitting diode (AMOLED) display. The display 302 has 286 pixels per inch (286 ppi) with a 400×400 resolution. The display 302, in this example, supports 16.7 million colors and has a maximum brightness of 300 nits. The display 302 also has a theoretical contrast ratio of 2,000,000:1 and a conservative contrast ratio of 10,000:1. The display 302 may further include a touch screen display that receives commands based on touch input from a user. While the above-described characteristics refer to one example embodiment, many other display characteristics may be employed in other embodiments, based on available technology.

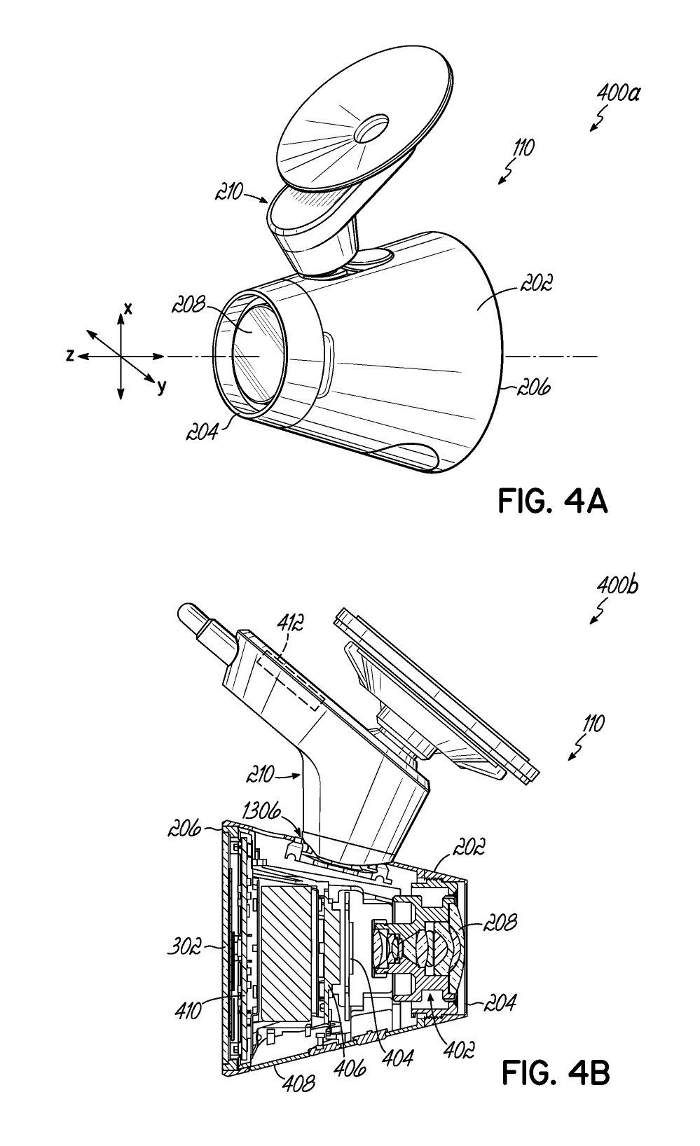

FIGS. 4A and 4B illustrate details of some of the internal components of the portable video capture device 110 of FIGS. 2 and 3. FIG. 4A is a three-dimensional view 400a of the portable video capture device 110 of FIGS. 2 and 3 with an XYZ coordinate system used to define a cross-section view, in accordance with an embodiment. FIG. 4B is a cross sectional view 400b of the portable video capture device 110 of FIGS. 2, 3, and 4A. The cross-section view is defined so that the plane of FIG. 4B corresponds to a slice through the portable video capture device 110 of FIG. 4A corresponding to the X-Z plane of FIG. 4A. In this example, the portable video capture device 110 includes an optical system 402, a sensor board 404, a WiFi board 406, a WiFi antenna 408, a main board 410, and the visual display 302 (discussed above). The mounting device 210 may further include a GPS module 412. The above listed components are described in further detail below. In further embodiments, the GPS board 518, antenna 520, and GPS module 522 may be housed as an internal component of the portable video capture device 110.

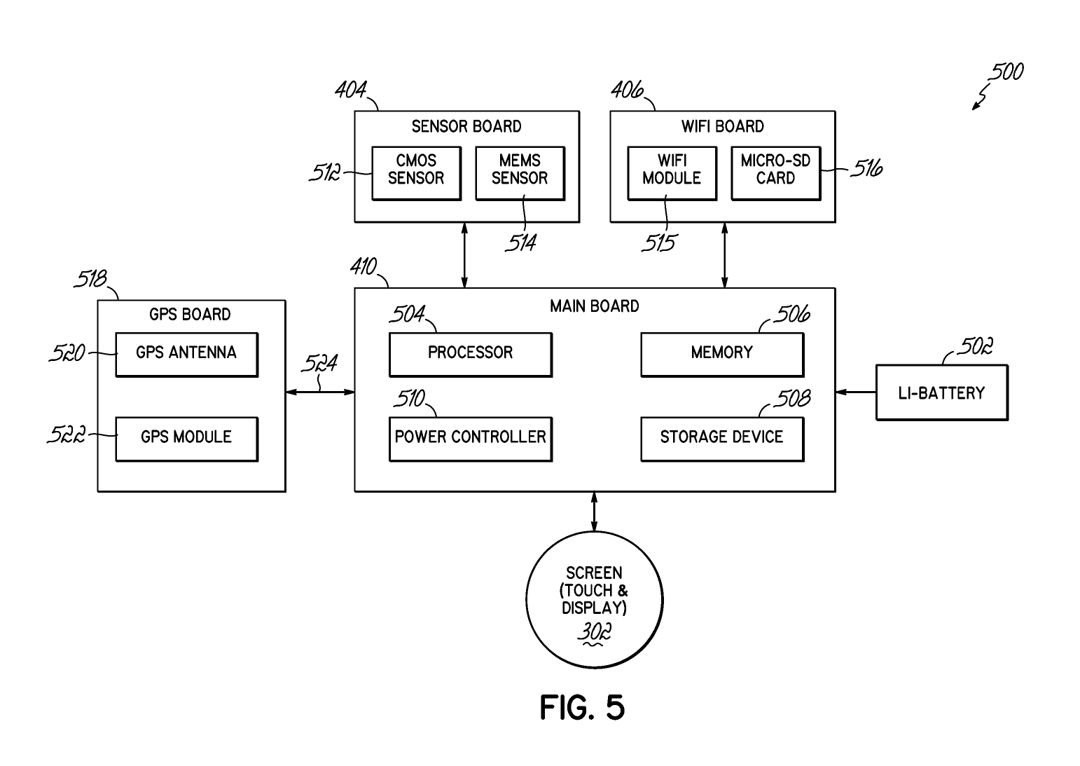

In an example embodiment, the optical system 402 may include a compound lens system having 7 aspherical lens elements housed in a metal barrel. The optical system may provide a 157° wide-angle view with a f/2.4 aperture. The optical system 402 may further include a fixed-focus configuration. The sensor board 404, WiFi board 406, main board 410, and the visual display 302, are discussed in greater detail below with reference to FIG. 5.

FIG. 5 illustrates a configuration 500 in which the sensor board 404, WiFi board 406, and visual display 302, are connected to the main board 410. The configuration 500 may further include a power source such as a lithium-ion battery 502 or an external power cable (not shown). For example, the lithium-ion battery 502 may be a replaceable CR2032 lithium ion battery. Some embodiments may include an external power cable including a Universal Serial Bus (USB) connection. For example, the power cable may include a USB to micro-USB connection. The power cable may be configured to receive an electrical power connection from an automobile power cable. In some embodiments, the external power cable may be provided with an adapter that is compatible with a cigarette lighter power source. According to an embodiment, the portable video capture device 110 draws power from replaceable and potentially rechargeable batteries, 12 V DC power, or 100-240V 50/60 Hz AC power, and the power controller 510 that converts AC to DC power.

The main board 410 further includes a processor 504, a random-access memory 506, and a flash memory 508. According to an embodiment, the processor 504 may be specially designed to processes video and image data. For example, processor 504 may be an S2L IP Camera Processor manufactured by Ambarella, Inc. (Santa Clara, Calif. USA) or other suitable commercially available processor. The processor 504 may be configured to perform image processing operations at a rate of 318 million pixels per second (318 M Pixels/sec) and to record video in various modes (e.g., day time recording mode, a night recording mode, etc.). The processor 504 may be configured to perform video recording operations having a variety of speeds and formats. For example, processor 504 may be configured to record video with 1080p format at 60 frames per second (i.e., 1080p/60 fps), with 1080p format at 30 frames per second (i.e., 1080p/30 fps), 720p format at 120 frames per second (i.e., 720p/120 fps), with 720p format at 120 frames per second (i.e., 720p/120 fps), with 640/360 format at 60 frames per second (640/360 60 fps), etc.

Processor 504 may be configured to perform video compression according to the H.264 Advanced Video Compression Standard (H.264/MPEG-4 AVC, developed by the ITU-T Video Coding Experts Group (VCEG) together with the ISO/IEC JTC1 Moving Picture Experts Group (MPEG)). Processor 504 may be configured to perform, slow-motion video encoding (e.g., using 720p HD at 120 fps), time-lapse video encoding, and multiple stream encoding. Using multiple stream encoding, processor 504 may encode raw video data to generate first, second, and third compressed video data sets, respectively having low, medium, and high resolution.

For example, processor 504 may encode raw video data to generate H.264 1080p data at 60 fps as the high-resolution data set and to generate H.264 640/360 data at 60 fps as the medium-resolution data set. Processor 504 may encode raw video data using MJPEG compression at 1 fps as the low-resolution data set. According to an embodiment, processor 504 may generate the first, second, and third compressed video data sets, respectively having low, medium, and high resolution, in real time while raw video data is being recorded. The generated compressed video data sets may then be written to a computer readable storage medium, such as random-access memory 506 or a flash memory 508, as described in further detail below.

According to an embodiment, the random-access memory 506 may be a double data rate type three (DDR3) synchronous dynamic random-access memory (SDRAM). Such a random-access memory 506 enables high bandwidth data transfer rates that may be many times the memory clock cycle. For example, in certain embodiments, random-access memory 506 may transfer data as fast as 64 times the memory clock cycle (assuming a 64-bit wide DDR3 module with two transfers per cycle of a quadrupled clock cycle). Thus, with a memory clock frequency of 100 MHz, a DDR3 SDRAM gives a maximum transfer rate of 6,400 MB/s.

According to an embodiment, a non-transitory computer readable storage medium, such as flash memory 508, may be provided. Raw video data and compressed video data may be stored in flash memory 508 when long-term storage is required. In further embodiments, computer program instructions may be stored on flash memory 508 that, when executed by a processor, cause the processor to control the portable video capture device 110.

According to an embodiment, flash memory 508 may be a NAND flash memory or a NOR flash memory. NAND flash memory has an advantage in that it enables fast write and erase operations but has a disadvantage in that random access is relatively slow. NOR flash memory provides better random access but generally has slower read, write, and erase performance relative to NAND flash memory. In certain embodiments, NAND flash memory enables data transfer rates from 1-30 MBytes/sec and may provide from 128 MByte-2 TByte of storage. In further embodiments, other non-transitory computer storage media may be employed based on available technology.

The sensor board 404 may include one or more image capture sensors 512. In an embodiment, an active pixel sensor (APS) may be used. An APS is an image sensor that includes an array of pixel sensors coupled to an integrated circuit that processes signals generated by the array of pixel sensors. Each pixel sensor may incorporate a photodetector and an active amplifier. An APS may be based on CMOS technology and is therefore often referred to as a CMOS sensor 512. The CMOS sensor 512 may have an optical size of 1/1.8 inches and have pixels that are 2.4 μm×2.4 μm in size. The CMOS sensor 512 may be configured as a back-illuminated structure and have high sensitivity and high dynamic range. The CMOS sensor 512 may operate in a high light performance (HLP) mode as well as in a low light performance (LLP) mode. In other embodiments, other image capture sensors may be employed using available technology.

The sensor board 404 may include several other sensors including one or more microphones, a three-axis accelerometer, a three-axis gyroscope, and a three-axis magnetometer. The sensor board 404 may also include a thermometer and a barometer. These various additional sensors may be based configured as MicroElectrical-Mechanical Systems (MEMS). The sensor board 404 may therefore include various MEMS sensors 514 as described in greater detail below.

MEMS sensors may be made of components between 1 and 100 μm in size (i.e. 0.001 to 0.1 mm), and MEMS devices generally range in size from 20 μm to a millimeter (i.e. 0.02 to 1.0 mm). MEMS sensors are often arranged in arrays and therefore can be on the order of 1000 mm² or larger. MEMS sensors are manufactured using semiconductor processing technology and generally have a central data processing unit (i.e., a microprocessor).

The WiFi board 406 includes a WiFi module 515 that provides Smart WiFi connectivity 106 as described with reference to FIG. 1, above, and described in further detail below. In further embodiments, the WiFi board 406 may include a removable non-transitory storage medium such as a Micro-SD card 516 that provides up to 128 GByte of storage.

The main board 410 may further be configured to communicate with a GPS board 518. The GPS board 518 may include a GPS antenna 520 and a GPS module 522. As described above with respect to FIG. 4B, the GPS antenna 520 and GPS module 522 may be configured to reside in the mounting device 210. In further embodiments, the GPS board 518, antenna 520, and GPS module 522 may be housed as an internal component of the portable video capture device 110. Further, the GPS board 518 may be connected to the main board 410 via a USB connection 524. The GPS antenna 520 and GPS module 522 may be configured to generate position information from the GPS signals. Further, the position information may be updated at a rate of no less than 6 Hz. For example, the position information may be updated at a rate of 10 Hz GPs or at any other rate as dictated by available technology.

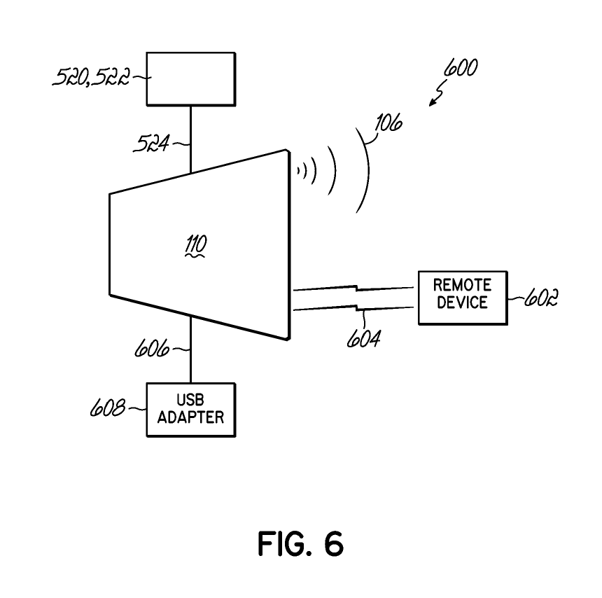

FIG. 6 is a schematic illustration 600 of the portable video capture device 110 configured to interact with several external devices, according to an embodiment. The portable video capture device 110 may interact with the GPS antenna 520 and GPS module 522 through a wired connection 524 and may interact with one or more remote devices 602 with a wireless connection 604 using Smart WiFi connectivity 106 (see FIG. 1) as described above. Wireless connections may also be established using other protocols such as, but not limited to, infrared, 802.11 wireless communication, mobile phone networks, Bluetooth communication 604, Low Energy Bluetooth communication, unlicensed short range radio frequency, according to the US FCC Code of Federal Regulations (CFR), Title 47, Part 15. The portable video capture device 110 may have additional wired connections. For example, the portable video capture device 110 may be connected by an additional USB connection 606 to a USB adapter 608. According to an embodiment, the USB adapter 608 may include a 5-pin port (not shown) that connects with the portable video capture device 110 and may further have a micro-USB port to connect with other devices.

According to an embodiment, the remote device 602 may be a remote-control device that may be used to issue control commands to the portable video capture device 110. For example, the remote device 602 may communicate with portable video capture device 110 using the Bluetooth Low Energy protocol. As such, the remote-control device 602 may be a stand-alone device that is powered by a battery. For example, remote-control device 602 may be powered by a replaceable CR2032 lithium ion battery. The remote-control device 602 may further include a CC2541 Bluetooth Low Energy processor/transceiver. The remote-control device 602 may be configured as a pushbutton switch that may be installed on an automobile steering wheel using a mounting strap (not shown). A user may issue commands to the portable video capture device 110 using the remote-control device 602. For example, by pushing a button on the remote-control device 602, a user may send a command to the portable video capture device 110 to highlight or index a segment of video as it is being captured.

According to an embodiment, the remote device 602 may be a module that communicates time dependent automotive on-board diagnostic (OBD) information from an operating automobile to the portable video capture device 110. For example, the remote device 602 may have a wired connection to an automobile's on-board computer. The remote device 602 may then communicate various pieces of vehicle performance data to the portable video capture device 110 via the wireless connection 604. For example, remote device 602 may communicate engine speed, engine revolutions per minute (RPM), throttle position, manifold pressure (i.e., “boost”), mass air-flow rate, etc. The OBD information transmitted by the remote device 602 may then be displayed on the visual display 302 (see FIGS. 3-5) and/or may be encoded with video data as time dependent visual display of the OBD information superimposed on video data. In an example embodiment, the remote device 602 may be an OBD II device.

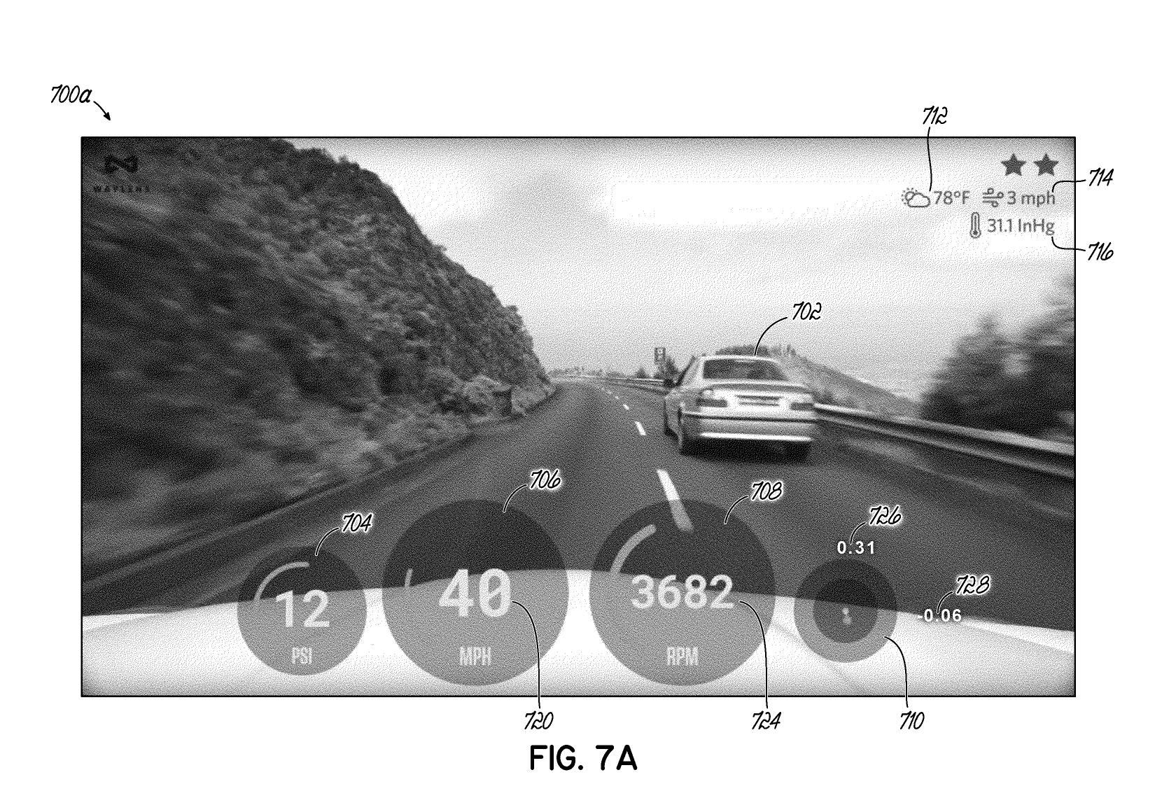

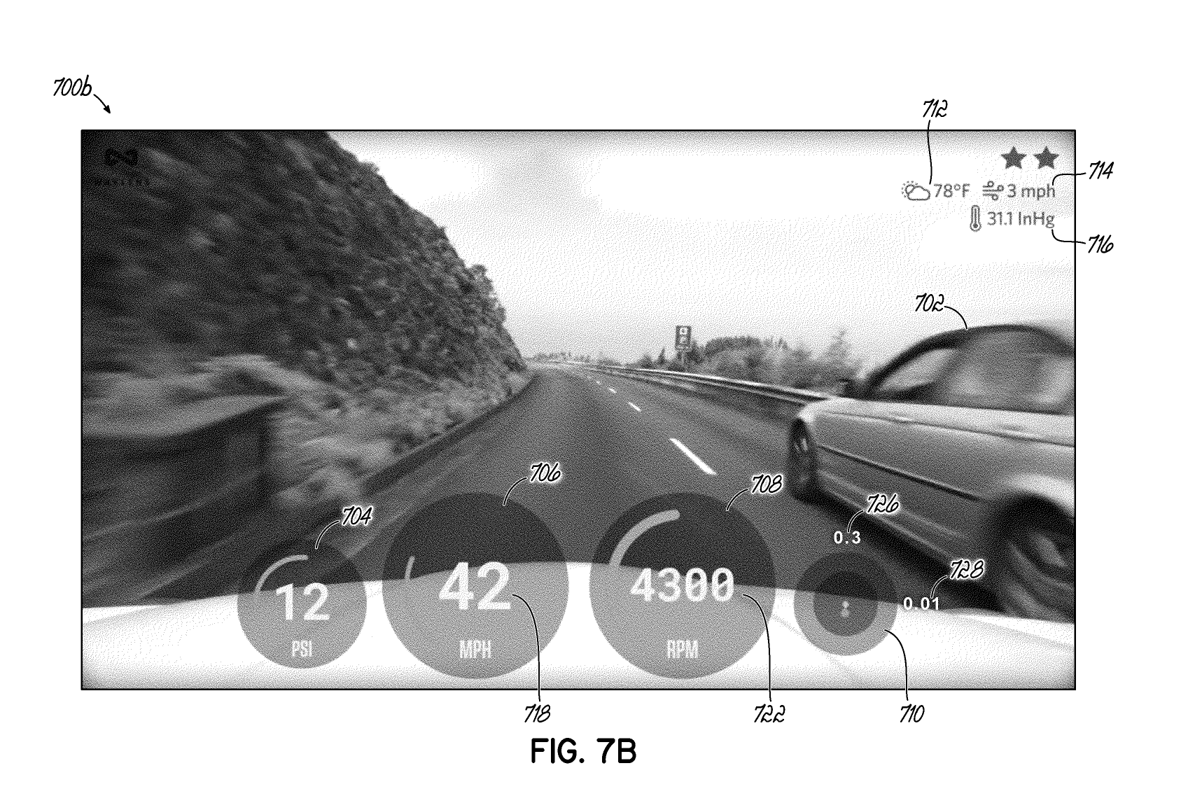

FIGS. 7A and 7B illustrate snapshots of video data captured by the portable video capture device 110 along with data from various sensors shown as a visual display superimposed on video data, according to an embodiment. FIG. 7A shows a first snapshot 700a of video data captured by the portable video capture device 110 that is mounted to a windshield in a moving automobile. In this example, the automobile in which the portable video capture device 110 is installed, captures video data as it passes another automobile 702. The visual display of data includes a boost gauge 704 that displays an engine manifold pressure, a speed gauge 706 the displays the automobile's speed relative to the ground, an RPM gauge 708 that displays engine RPM, and an acceleration gauge 710 that provides two-dimensional data obtained from an accelerometer. The visual display of data further includes a temperature indicator 712 that displays an outdoor temperature, a wind speed indicator 714 that displays an outdoor wind speed, and a pressure indicator 716 that displays an outdoor barometric pressure.

FIG. 7B shows a second snapshot 700b of video data captured by the portable video capture device 110. In this example, the automobile to which the portable video capture device 110 is mounted, is in the process of overtaking the other automobile 702. In this example, the speed reading 718 shown in the speed indicator 706 has increased from the corresponding speed reading 720 shown on the speed indicator 706 of the first snapshot 700a of FIG. 7A. This illustrates that fact that the various gauges, 704-716, provide real-time data that is continuously updated as changes occur.

This can also be seen from the readings of the RMP gauge 708. For example, the RMP reading 722 displayed on the RPM gauge 708 in the second snapshot 700b has increased from the corresponding reading 724 displayed on the RPM gauge 708 in the first snapshot 700a. The changing readings on the speed gauge 706 and the RMP gauge 708 indicate that the automobile in which the portable video capture device 110 is mounted is accelerating as it passes the other automobile 702. That the automobile is accelerating is further confirmed by the changing readings shown on the acceleration gauge 710. In the first snapshot 700a, the acceleration gauge 710 shows a first value 726 of the acceleration in a forward direction, and a first value 728 of the acceleration in a lateral direction. Correspondingly, in the second snapshot 700b, the acceleration in the forward direction has changed to a second value 726, and the acceleration in the lateral direction has changed to a second value 728, as shown by the readings on the acceleration gauge 710.

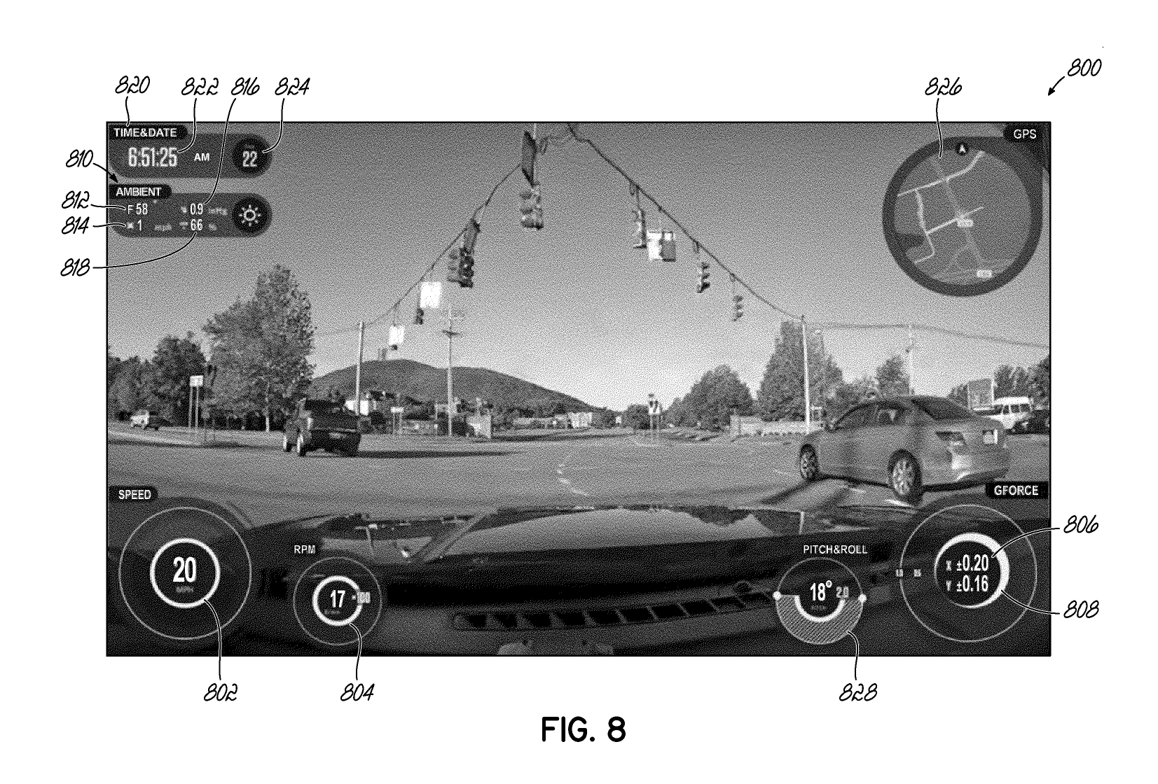

FIG. 8 illustrates a third snapshot 800 of video data captured by the portable video capture device 110, according to an embodiment. As in the examples of FIGS. 7A and 7B, various pieces of real-time data are shown as a visual display superimposed on video data. For example, speed data is displayed on a speed gauge 802 having a slightly different visual appearance from that of the speed gauge 706 of FIGS. 7A and 7B. Similarly, RPM data is displayed on an RPM gauge 804 having a slightly different visual appearance from that of the RPM gauge 708 of FIGS. 7A and 7B.

In this example, the acceleration gauge 806 (labeled “GFORCE”) provides acceleration data in a forward direction (labeled “x”) and a lateral direction (labeled “y”) in a slightly different format from that displayed in the acceleration gauge 710 of FIGS. 7A and 7B. The acceleration gauge 806 further provides a visual indicator of the net magnitude and direction of the acceleration in the form of a “crescent moon” shape 808. In this example, an ambient conditions gauge 810 provides temperature 812, wind speed 814, and pressure 816, as was shown in FIGS. 7A and 7B (shown as values 712, 714, and 716, in FIGS. 7A and 7B, respectively). In this example, the ambient conditions gauge 810 includes a new piece of data in the form of the relative humidity 818.

According to an embodiment, user selections may determine what data is displayed superimposed on video data. For example, a user may choose to have a time and data indictor 820 to display a time 822 and date 824, as shown in FIG. 8. Further, user may choose to have a GPS indicator 826 that displays GPS map data. Other user-selectable indicators may provide further position data, such as angular position data of the portable video capture device relative to a nominal horizontal orientation. For example, a pitch & roll indicator 828 may be provided. The example pitch and roll indicator 828 may provide real-time data regarding rotations of the automobile about an axis aligned with the driving direction (i.e., roll) and/or regarding rotations of the automobile about an axis perpendicular to the driving direction (pitch). The configuration and operation of the portable video capture device 110 is controlled by user commands that may be entered through a mobile control device 112 (see FIG. 1), as described in greater detail below.

As described above, the portable video capture device 110 includes a Smart WiFi connectivity 106 for enabling the portable video capture device 110 to directly connect with WiFi providers and gain Internet access. Typically, connecting to a WiFi access point (AP) requires authorization, answering challenges, and other user interactions beyond entering simple login credentials (e.g., entering a Service Set Identifier (SSID) and password). Connecting the portable video capture device 110 to a WiFi AP may be challenging because the portable video capture device 110 may lack a sufficiently large display and input device, such as a keyboard, to input SSID and password information of an AP.

According to an embodiment, the Smart WiFi connectivity 106 provides the portable video capture device 110 with the capability of acquiring WiFi connectivity from public and private WiFi providers in a streamlined fashion. The Smart WiFi connectivity 106 also provides sufficient bandwidth and speed for uploading large amounts of video and sensory data that may be lacking in a cellular connection. The Smart WiFi connectivity 106 consists of both hardware and software modules. The hardware component may include a TI WiLink 8 module, however, other implementations are possible using available technology. The Smart WiFi connectivity 106 enables the portable video capture device 110 to serve as a dual-role device. As such, the portable video capture device 110 may connect to the Internet via an existing AP, and further may function as a local AP providing connectivity to other devices such as mobile phones.

The portable video capture device 110 and the controlling device 112 may be connected by a direct WiFi connection, in which the portable video capture device 110 itself serves as an AP, and the mobile device 112 serves as a client. This connection setup may be chosen as a default configuration when controlling the portable video capture device 110 using the mobile device 112 (e.g., viewing device 130). Any challenges, including authentication requests and others, received by the dual-role device are forwarded to a connected device such as the controlling devices 112 (e.g., mobile phone). Responses to authentication requests, challenges, etc., may be received by a user interface of the controlling devices 112. It is in this respect that access may be granted to the portable video capture device 110 in a streamlined fashion.

Software modules may be implemented through a mobile device 112. The software modules, provided on a mobile device 112, may then provide instructions to the portable video capture device 110 to establish a connection between the portable video capture device 110 and an existing AP. The instructions may include any requested login credentials or answers to authentication challenges that are required to connect the portable video capture device 110 to the AP. Such requested login credentials or answers to authentication challenges may be received by the mobile interface from a user.

The Smart WiFi connectivity ensures that the portable video capture device 110 maintains a direct connection to the controlling device 112. In turn, the controlling device 112 enables the portable video capture device 110 to connect to an external AP to gain Internet connectivity. Configuring the Smart WiFi connectivity 106 in this way avoids the necessity of using a mobile phone as a relay or temporary storage device, when transferring large data files to the cloud 120.

The Smart WiFi connectivity 106, therefore, minimizes the number of steps users need to follow to enable such data transfers, and enables transfer of large amounts of data from generic sensing devices to the cloud wirelessly when such transfers require the speed and bandwidth provided only by WiFi.

A viewing device 130 (e.g., mobile device, web device, or other such device connected through a local or remote network), may also be configured to control (as a remote-control device 602) the portable video capture device 110 via remote control interface 138 of the viewing devices 130 to the remote-control interface 104 of the portable video capture device 110. The viewing device 130 (e.g., mobile phone) may be configured with a mobile application, such as a native app or a web app, that enables the user to provide control data for controlling the portable video capture device 110. Specifically, the mobile application may provide a user interface for the user to specify various configurations for the portable video capture device 110.

The mobile application on the viewing device 130 may be initiated by a user that is sufficiently close to the portable video capture device 110 to enable Smart WiFi connectivity 106. The viewing device 103 may the transmit configuration and control data from the remote-control interface 138 of the viewing device 103, to the remote-control interface 104 of the portable video capture device 110, using a WiFi connection provided by the Smart WiFi connectivity 106. In turn, one or more processors of the portable video capture device 110 receive and process the configuration and control data transmitted by the viewing device 130.

The mobile application may also be initiated by a user at a remote location from the portable video capture device 110 such that the mobile application, on the viewing device 130, transmits the specified control data, via the cloud service 122, to the portable video capture device 110 or a remote server thereof (e.g., in the cloud). The one or more processors of the portable video capture device 110 receive or retrieve the specified configuration, directly from the viewing device 130 via WiFi Connectivity 106, or from a remote server via mobile control interface 112, also via WiFi Connectivity 106.

The viewing device 130 may also include other devices for controlling the portable video capture device 110. For example, the viewing device 130 may be a Smart watch application or another wearable device that includes a sensor (e.g., accelerometer) that tracks the direction of a user's head. That is, as the wearable device user rotates his head, the wearable device transmits the sensor measurements to the portable video capture device 110. In some embodiments, the viewing direction of the portable video capture device 110 may be controlled based on measurements taken by the wearable device.

The application of wearable technology described above includes, but is not limited to, an automobile driver in a vehicle, such that the portable video capture device 110 on board the vehicle records the visual data in the viewing direction of the driver. Similarly, the portable video capture device 110 may include, but is not limited to, displaying a live stream of video to a remote user who is wearing a virtual reality headset, such as, but not limited to, an Oculus headset. As the remote user rotates his head, the viewing direction of the portable video capture device 110 may be configured to rotate in the same direction, giving the remote user a virtual reality experience of being in the location of the portable video capture device 110.

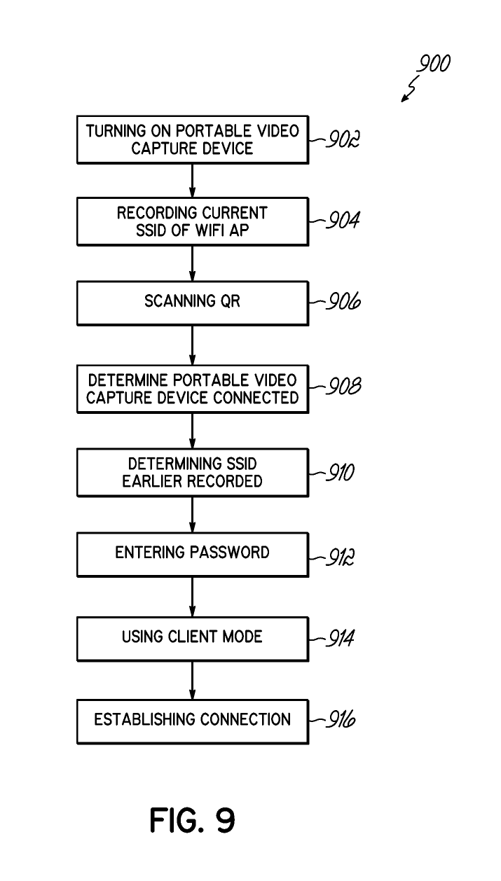

FIG. 9 is flowchart illustrating an example method 900 of configuring a portable video capture device 110 to enable Smart WiFi connectivity 106, according to an embodiment. In a first part of the method, defined by stages 902 through 908, a direct WiFi connection is established between the portable video capture device 110 and a mobile device 112, 130. In a second part of the method, defined by stages 910 through 916 a direct WiFi connection is established between the portable video capture device 110 and a WiFi AP, thereby providing a direct WiFi based Internet connection to the portable video capture device 110. The mobile device is assumed to be connected to a first WiFi AP. Upon completion of the method, the portable video capture device 110 may be connected to the same (i.e., the first) WiFi AP as the mobile device 112, 130, or the portable video capture device 110 may connect to a second WiFi AP based on a user selection.

The first part of the method begins at stage 902 with turning on the portable video capture device 110. When the portable video capture device 110 is turned on in stage 902, the portable video capture device 110 may be configured to automatically display (e.g., on display device 302) a Quick Response (QR) code with and embedded SSID and password for the AP that is associated with the portable video capture device 110. According to an embodiment, the portable video capture device 110 may be configured to have both client and AP mode enabled, that is, portable video capture device 110 may be running in a due dual-mode configuration.

At stage 904, an operating system running on the mobile device 112, 130, that is connected to the first WiFi AP, may receive and record an SSID associated with the first WiFi AP. In the second part of the method, in stages 910 through 916, the SSID associated with the first WiFi AP, that is stored on the mobile device in stage 904, may be used in stage 910 to establish a direct connection between the portable video capture device 110 and the first WiFi AP, according to a user selection indicating that such a connection is desired.

At stage 906 a user may use an application running on the mobile device 112, 130 to scan the QR code that is displayed on display device 302 of the portable video capture device 110. Upon successfully scanning the QR code, the application running on the mobile device 112, 130 decodes the QR code to thereby receive the SSID and password that is associated with the WiFi AP of portable video capture device 110. The SSID and password that is associated with the portable video capture device 110 may then be used by the mobile device 112, 130 to establish a connection between the mobile device 112, 130 and the portable video capture device 110.

The mobile application may then display the SSID that is associated with the portable video capture device 110 on a screen of the mobile device 112 and may then copy the password to a clipboard. The user of the mobile device 112, 130 may then be prompted by the mobile device 112, 130 to perform a procedure to connect the portable video capture device 110 to the mobile device 112 using the SSID and password associated with the portable video capture device 110 that was determined by scanning the QR code in stage 906. For example, the mobile device may prompt a user to go to a settings menu on the mobile device 112 to connect to the portable video capture device 110 with the given SSID by pasting the password from the clipboard. Through this process, the mobile device 112 and the portable video capture device 110 become connected through a direct WiFi communication link.

At stage 908, the mobile application determines that the portable video capture device 110 has been connected and the mobile application may then generate a report indicating that the portable video capture device 110 has been successfully connected. Alternatively, the report may indicate that an error has occurred and that the connection was not successfully completed.

The second part of the method begins with stage 910. In stage 910 the application running on the mobile device 112 recovers the SSID that was recorded in stage 904 and that corresponding to the first WiFi network to which the mobile device is connected. The mobile application may then prompt a user to verify that the user wishes to connect the portable video capture device 110 to the same (i.e., the first) WiFi network to which the mobile device is connected. Alternatively, the user may select a second WiFi AP from a list of other SSID's corresponding to other WiFi connections that are accessible to the portable video capture device 110. Once a selection of an SSID (i.e., first WiFi or second WiFi) has been made, the method proceeds to prompt the user, in stage 912, to enter a password that may be used to connect the portable video capture device 110 to the WiFi connection associated with the selected SSID. At stage 912, the user may enter a password at the mobile device 112. The user may then select (e.g., click) a “connect” option. At stage 914, the portable video capture device 110 may use a client mode to establish a direct connection to the WiFi AP associated with the selected SSID.

Based on the results of the connection, a success or error message may be presented to the user on the mobile device 112, 130. At stage 916, upon success, the mobile application reminds a user that a connection has been successfully established between the portable video capture device 110 and the selected external WiFi. At this point, the external WiFi may challenge the portable video capture device 110 for further authentication, and such challenges may be forwarded from the portable video capture device 110 to the mobile device 112, 130 for resolution.

After the method 900 is performed for a first time, configuration information (e.g., SSID's and passwords) may be stored for future connections. Future connection may be initiated automatically if the first WiFi (to which the mobile device 112, 130 is connected) and the WiFi to which the portable video capture device 110 is connected (i.e., either the first WiFi or a selected second WiFi) do not change. Generally, method 900 would only need to be manually performed when the mobile device 112, 130 and/or the portable video capture device 110 encounters new external WiFi AP(s).

To summarize: the method 900 of FIG. 9 allows the mobile device 112, 130 which is connected to a first external WiFi AP, to control the portable video capture device 110 through a direct WiFi connection between the mobile device 112, 130 and the portable video capture device 110. Further, a direct WiFi connection between the portable video capture device 110 and an external WiFi AP (i.e., either the first WiFi AP or a selected second WiFi AP) is established through which the portable video capture device 110 may gain direct Internet access. In this way, large video data sets may be transferred directly from the portable video capture device 110 to a WiFi AP while bypassing the mobile device 112, 130.

Depending on the network setup, the portable video capture device 110 may receive commands for controlling its direction via a “push” or “pull” mode. In embodiments where a direct socket connection can be established between the portable video capture device 110 and the remote controlling device 130, after meeting authentication requirements, the remote controlling device 130 may send commands directly to the portable video capture device 110 through the socket connection (i.e., the push mode). In embodiments where such direct connection cannot be established (e.g., when the portable video capture device 110 is not connected to the Internet via 4G/LTE module or WiFi), but needs to route through a connected device (e.g., mobile device 112), the remote controlling device 130 may send commands to the cloud 120 and may cache the commands in a queue. The portable video capture device 110 may then periodically pull commands from this queue and execute them via the one or more processors of the portable video capture device 110.

The connected camera system 100 includes a cloud service infrastructure 120 for streaming visual contents through the cloud in an intelligent and adaptive manner. The cloud service infrastructure 120 functions in conjunction with the WiFi Connectivity 106 described above. Depending on the availability and quality of different types of connectivity on the device, such as WiFi or cellular connection, the device may be configured to adaptively adjust the streaming of video or other sensory contents with different size and compression quality, including periodic static image shots instead of videos. In the absence of direct connection to the Internet on the portable video capture device 110, the connected camera system 100 includes a software system that enables streaming through a pairing mobile device (such as 112 in FIG. 1) with Internet connectivity. The mobile device 112 establishes links to both the portable video capture device 110 via WiFi and the Internet, and may be configured to pull contents off the portable video capture device 110 and stream the contents through the cloud.

The disclosed connected camera system 100 is configured with hardware and software that provides functionality to bookmark (or highlight) a video segment, or segment of other visual data, captured by the sensors of the portable video capture device 110. Such capability enables users to quickly and effectively identify, locate, and mark the most interesting video segments among lengthy raw video contents, which may be later edited, uploaded to the cloud, and shared. This functionality addresses the need to locate video segments of interest that are often a small fraction of the total captured content and may be difficult to locate and extract.

In some embodiments, the viewing device 130 (via a mobile application) may bookmark (or highlight) the presented captured data, that is presented on display device 302, streamed to viewing device 130, or downloaded/stored on the viewing device 130. In the streamed captured data embodiments, the viewing device 130 transmits (streams) user-input for bookmarking/highlighting a visual data segment at the mobile application from the viewing device 130, via cloud service 120, to the portable video capture device 110, wherein the one or more processors at the portable video capture device 110 may update the display device 302.

In the embodiments where the bookmarking/highlighting is performed directly on the display, hardware devices may be used for bookmarking or highlighting the captured visual data. For example, a clickable button may be provided on the main body of the portable video capture device 110 or on a power cord for bookmarking/highlighting the captured visual data. For another example, the remote device 602, acting as a remote-control, as described above, may be attached to a steering wheel in an automobile configured with the connected camera system 100.

In other embodiments, the portable video capture device 110 may be configured with an audio/voice recognition device, which transmits a signal to the one or more processors on the portable video capture device 110 (e.g., via Smart WiFi connectivity 106) to bookmark/highlight the current captured segments of the visual data. Non-limiting examples of audio/voice commands include triggered audio recognition of predefined sound signatures, such as passengers laughing, and motion detection of predetermined patterns, such as sudden acceleration. The portable video capture device 110 may be configured to capture both visual data (e.g. image, video, etc.) and other sensory data streams, including GPS, accelerometer, compass, OBD II, for a given sampling rate for bookmarking and highlighting. The highlighted/bookmarked data may be stored (recorded) on the portable video capture device 110 in memory 506 or on a non-transitory computer 508 readable storage device or streamed to the viewing device 130 to be stored (recorded) in memory or on a non-transitory computer readable storage device.

Bookmarked/highlighted points in the captured data, placed in real-time along a time axis, are converted into short video segments according to user settings (provided via a mobile application on the viewing devices 130). These segments provide a starting basis for further editing, particularly length adjustment editing, via the mobile application of the viewing devices 130 (or other such application on other devices). Further, the portable video capture device 110 and viewing devices 130 may be configured with middleware that best manages and preserves bookmarks, so that the bookmarks are kept preserved on the portable video capture device 110 before a user processes them, even when the memory storage of the device is full and rotational rewriting happens. The portable video capture device 110 may be configured to capture both visual and other sensory data streams, including GPS, accelerometer, compass, and OBD II data, for a given sampling rate. This bookmarking/highlighting ensures that the picture or video clip (individual frame or certain set/sequence of frames) is easy to locate while editing.

The connect camera system 100 includes various mechanisms or algorithms for bookmarking and highlighting a visual data segment of interest, which may be configured in the one or more processors of the portable video capture device 110 or the viewing devices 130 for execution by a mobile application. In some embodiments, the connected camera system 100 includes mechanisms, which in some embodiments may include machine learning, which automatically detects pre-defined events configured at the connected camera system 100. For example, the predefined events may be configured in the computer memory 506 of the portable video capture device 110, computer memory of the connecting devices 130, or in a database accessible to the cloud service 120.

The one or more processors of the portable video capture device 110 or connecting devices 130 may be configured to reference these predefined events, such as in its computer memory or via the cloud service 120, and to automatically bookmark/highlight the associated data of interest to a user (e.g., pictures, videos, etc.) when one of these pre-defined events occur during the capturing or displaying of the visual data. Further, the mechanisms may identify interesting data (e.g., pictures, videos, GPS reading, accelerometer reading, etc.) based on learning a user's previous selection during highlighting/bookmarking or editing, and store indications of the interesting data that corresponds to the previous selections as a predefined event for later referencing by the connected camera system 100.

Additionally, sensors configured in the connected camera system 100 may be programmed to detect predefined events (e.g., at certain thresholds, parameter values/ranges, and the like of a GPS, accelerometer, lighting sensors, etc.) of the images and video clips. The sensors may then transmit an indication to the one or more processors 504 of the portable video capture device 110 to automatically bookmark/highlight the visual data being captured or displayed at the time of the detected condition. In some embodiments, when one of the predefined events (detected threshold conditions) occurs, the portable video capture device 110 automatically inserts a bookmark/highlight into its current captured visual data (recording) without the user's manual action. The range and thresholds mentioned above may be either pre-defined by each individual user, or preset by the system through aggregated user preference learned by the cloud infrastructure 120. In some embodiments, the user may also manually insert bookmarks/highlighting into captured visual data, such as via the remote control or a mobile application executing on the controlling/viewing devices 112, 130.

The automatic bookmarking/highlighting may be triggered by events that include: GPS coordinates of the event falling into a predetermined range, speed (e.g., of a car in which the connected camera system 100 is installed) exceeding a predetermined value, data detected by an OBD II connection exceeding a predetermined threshold, acceleration (e.g., of a car in which the connected camera system 100 is installed) along a particular axis exceeding a predetermined value, and angles of the portable video capture device's 110 absolute orientation, such as pitch and roll angles, exceed certain thresholds.

In some embodiments, the connected camera system 100 includes additional algorithms used to automatically highlight interesting data (e.g., pictures, videos, GPS reading, accelerometer readings, etc.) if the data are captured within a defined area near a point-of-interest. Points of interest may be identified and defined using 3rd party databases such as Google Maps. Example points of interest may include but are not limited to bridges, tunnels, scenic overlooks, ocean front roads, etc. Points of interest may also be identified and defined through machine learning of where other users have taken or manually highlighted images and video in the past.

Similarly, the one or more processors 504 of the portable video capture device 110 or connecting devices 112, 130 may be configured to reference the 3rd party databases, such as via the cloud service 120 and WiFi connectivity 106, and to automatically bookmark/highlight the associated data of interest to a user (e.g., pictures, videos, etc.) when one of these points-of-interest occurs during the portable video capture device 110 capturing or displaying of the visual data. Furthermore, disclosed embodiments may be configured to continuously update its point-of-interest data through its wireless connection to the cloud.

In some embodiments, the sensors configured in the connected camera system 100 includes an accelerometer that detects acceleration or a series of accelerations used to trigger automatically bookmarking/highlighting interesting data (e.g., pictures, videos, GPS state, accelerometer reading, etc.) during the capturing or displaying of visual data. One example application includes, but is not limited to, detecting accelerations from a bumpy road or from a curvy mountain road that trigger embodiments to automatically highlight data (e.g., pictures, videos, GPS state, accelerometer reading, etc.) captured at that location.

Further, in some embodiments, the connected camera system 100 may similarly use a microphone as a sensor that triggers automatic bookmarking/highlighting of interesting data (e.g., pictures, videos, GPS state, accelerometer reading, etc.) during the capturing or displaying of visual data. Alternative embodiments may use hand gestures as a trigger to auto highlight interesting data (e.g., pictures, videos, GPS reading, accelerometer reading, etc.).

In some embodiments, the connected camera system 100 may also employ image recognition technology to similarly detect objects of interest and highlight data (e.g., pictures, videos, GPS reading, accelerometer reading, etc.) during the time the object of interest was recorded. An example application includes, but is not limited to, detecting road signs, such as but not limited to U.S. State welcome signs, while traveling in an automobile. Further, the disclosed auto highlight functionality may also automatically switch on from sleep mode to recording mode.

All data sources (image, video, GPS, accelerometer, OBD II, etc.) may be recorded and saved during a highlighted event in the computer memory 506 of the portable video capture device 110 or at the viewing devices 112, 130. Furthermore, the highlighted event may include an adjustable time interval to highlight data both before and after the event is triggered. This includes both manually triggered highlight events and automatically triggered highlight events. In some embodiments, bookmarking may be triggered automatically and intelligently without physical intervention by a user, as described in greater detail below.

The advantages of the connected camera system 100 include, without limitation, a simplified method for recording a road trip from an automobile. The auto highlight capability allows the vehicle's driver and passengers to capture video and still images of all interesting parts of the trip automatically. The multiple sources of data, i.e., GPS, OBD II, accelerometer, add additional contextual information to the recorded video (visual data).

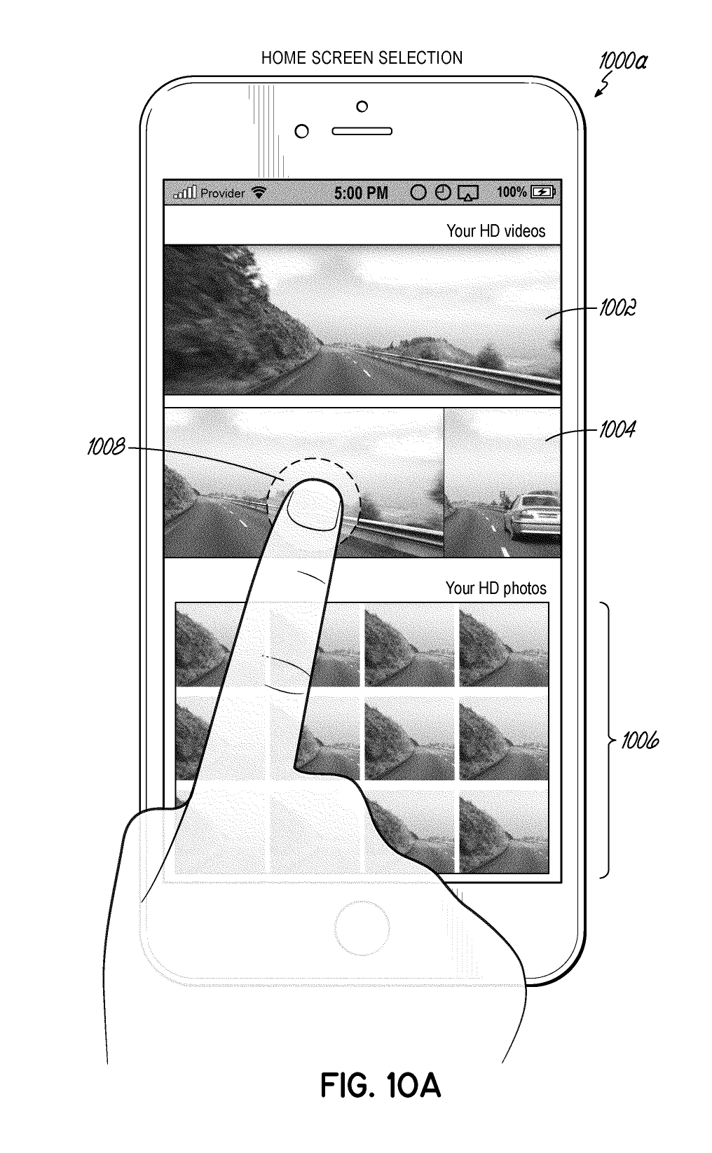

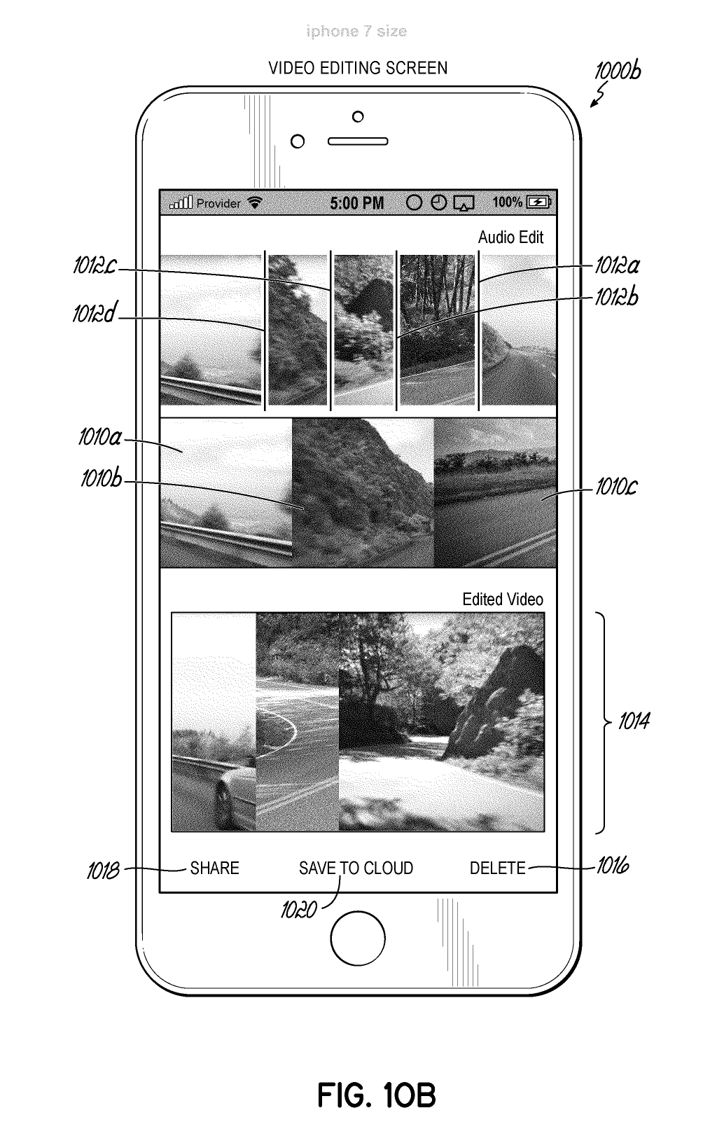

The disclosed embodiments include a mobile application that enables quick editing of captured video from the viewing devices 130 of the connect camera system 100. The mobile applications, shown in FIGS. 10A, 10B, 11A, 11B, 12A, and 12B, are examples of mobile application user interfaces and user experiences that enable the user to view and edit captured visual data. In some embodiments, these mobile applications may be used to edit the visual data at the portable video capture device 110, or based on streaming visual data provided to the viewing devices 130 by the portable video capture device 110. In other embodiments, the visual data may be downloaded (or recorded) to the viewing devices 130 for editing. FIGS. 10A, 10B, 11A, 11B, 12A, and 12B provide non-limiting examples of designs of the mobile application (the mobile application is not limited to the description or images below.)

FIG. 10A illustrates an example home screen (on the mobile application) displaying a library of bookmarked videos and photos captured by the portable video capture device 110, as described in greater detail below. The described algorithms for bookmarking/highlighting the raw video footage on the portable video capture device 110 allow the mobile application to present the most interesting and worthwhile clips (image or video segments) to users, so that the user may save time identifying and locating such clips in the visual data, and so that the user can make fast decisions on how to edit and share such clips (e.g., on the cloud 120).

As shown in FIG. 10A, the home screen 1000a of the mobile application displays a video 1002 and segments 1004 of visual data (i.e., a video) that was previously bookmarked/highlighted by a user. A collection of video images 1006 (i.e., still photographs) may also be shown on the home screen 1000a. A user may begin the process of video editing by selecting one of the video segments 1004. According to an embodiment, the user may select one of the video segments 1004 through interaction with a touch screen. For example, the user may touch a position 1008 on the touch screen to indicate a selection of one of the video segments 1004.

When the user selects one of the segments 1004 (i.e., clips) by providing touch screen input at position 1008 in the home screen 1000a, the mobile application may automatically display the video editing screen 1000b, as shown in FIG. 10B. The video editing screen 1000b shows the selected clip automatically split into focused moments 1010a, 1010b, and 1010c. The focused moments 1010a, 1010b, and 1010c represent portions of the video that may be played as repeated .gifs/time lapses in the mobile application. The user may swipe over or otherwise scroll (i.e., perform a “scrubbing” operation) to review the focused moments. In this example, the focused moments 1010a, 1010b, and 1010c are shown in relation to the rest of the video segments 1004 by visual indicators 1012a, 1012b, 1012c, and 1012d.

The mobile application selects and splits the selected clip into these moments 1010a, 1010b, and 1010c based on determining changes in the background, camera focus, or any other configured characteristic of the visual data. In the mobile application, the video editing screen 1000b of FIG. 10B enables the user to drag moments to various locations on the timeline 1014 (shown at the button of the edit screen) to edit the sequence of the moments. Further, the mobile application enables the user to highlight, and, then swipe (i.e., scroll or scrub), specific displayed moments, or using the “delete” button 1016, to delete a selected moment from the clip. In this way, visual data (e.g., a video) can be easily trimmed down by the user. The video can then be shared (using the shown “share” button 1018) to any social media platform, e.g., Facebook, twitter, Pinterest, Instagram, and the like, or stored (e.g., on the viewing device 130 or in the cloud 120). Videos and photos from other sources (such as but not limited to images and videos from a smartphone's camera, Dropbox folder, Google drive folder, GoPro or other action CAM, DSLR CAM, etc.) can be also added to the current clip being edited, using an “add” button (not shown). The updated clip may be saved locally to the viewing device 130 or the “save to cloud” button 1020 may be selected to save the updated clip to the cloud 120.

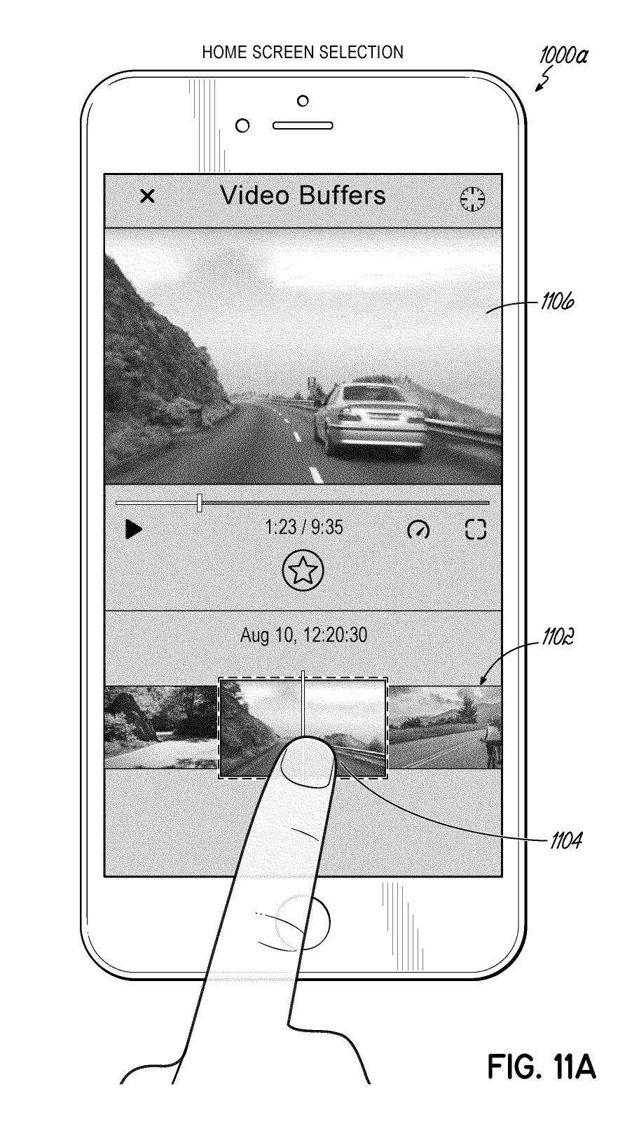

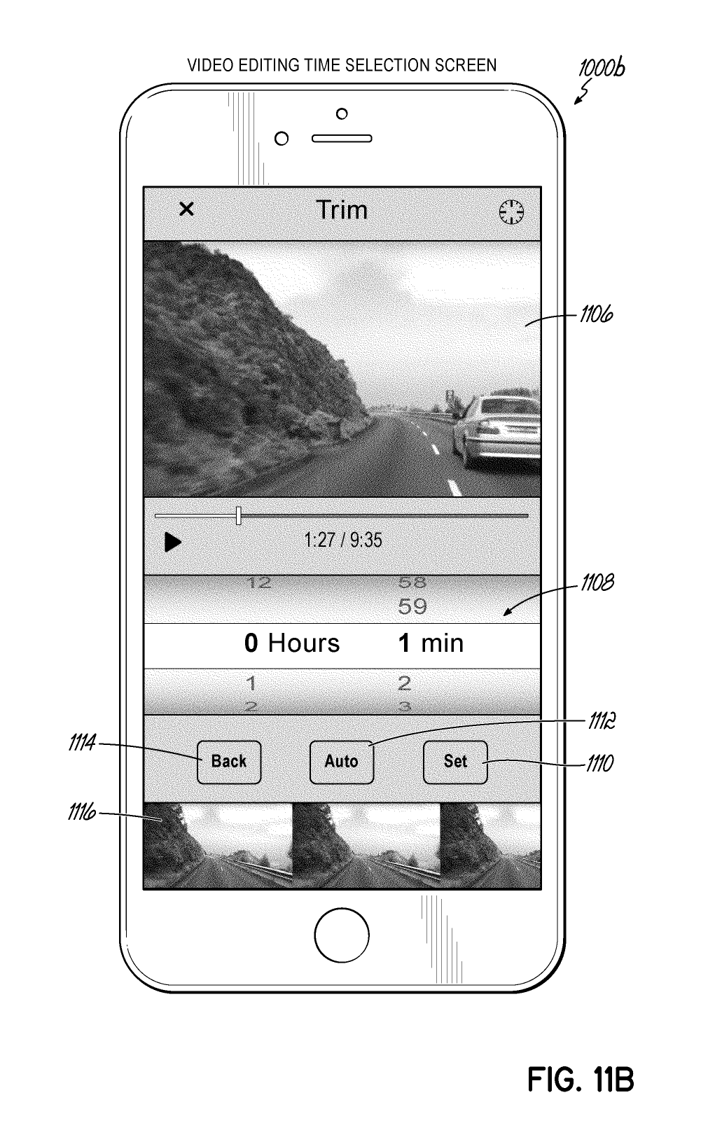

FIGS. 11A and 11B illustrate alternative embodiments of the mobile application. In this example shown in FIG. 11A, the home screen 1000a shows a library 1102 of videos and photos taken on an automobile trip in a revolving manner for the photos, and in a scrolling manner for videos. The videos may be further listed in a time lapsed manner, and the user may touch 1104 to revolve the videos around to find a video to select. The user may then select a clip to be edited, which is displayed on the “video editing/time selection screen” screen 1000b shown in FIG. 11B. In this example, the selected clip 1006 to be edited is displayed at the top and is displayed based on time intervals chosen in the center 1108 of the screen.

The user may edit (or trim) the clip by selecting time intervals in the center 1108 of the screen and by selecting the “set” 1110, “auto” 1112, and “back” 1114 buttons. According to this procedure the clip 1106, shown at the top of the screen, may be edited down to specific times (user-specified time periods) of the video. By swiping (scrolling or scrubbing) the clip 1106, at the bottom 1116 of the screen, the user may select parts of the video to keep, delete, or to share. For portions of the 1106 that are desired to be saved, the process of defining time intervals may be repeated to more finely define the clip. The bottom 1116 of the screen constantly shows a visual indicator corresponding to the edited clip playing in real-time as the clip is edited. The visual indicator shown at the bottom 1116 of the screen may be continuously updated to correspond to changes being made in real time to more finely edit the clip 1106.

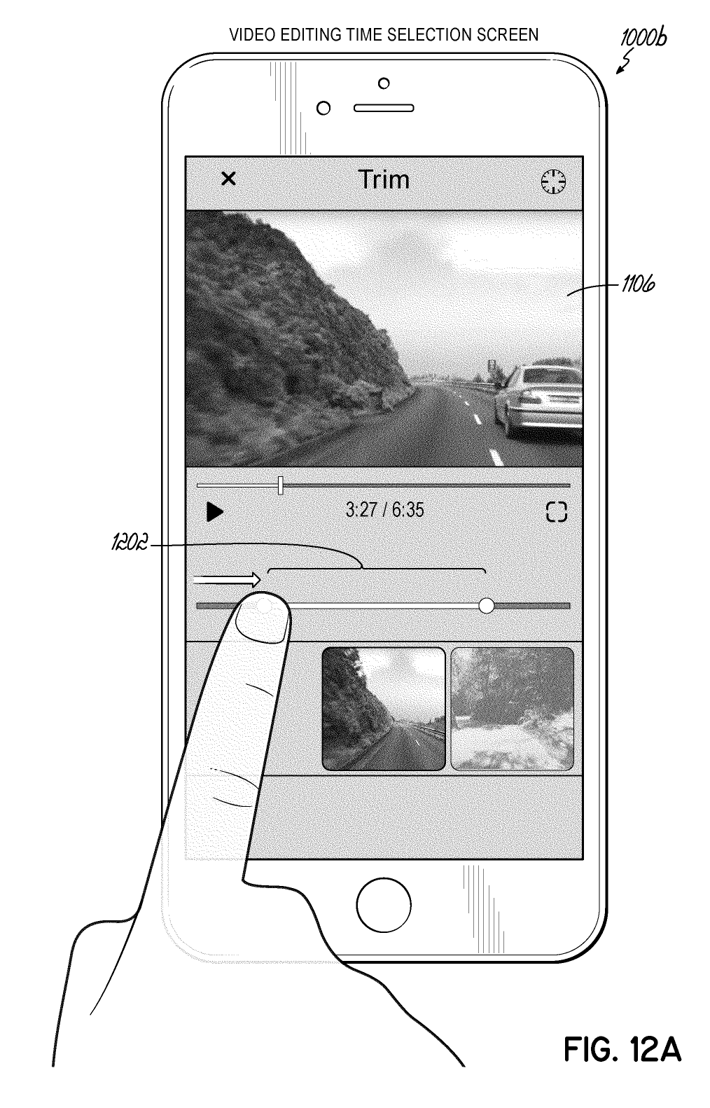

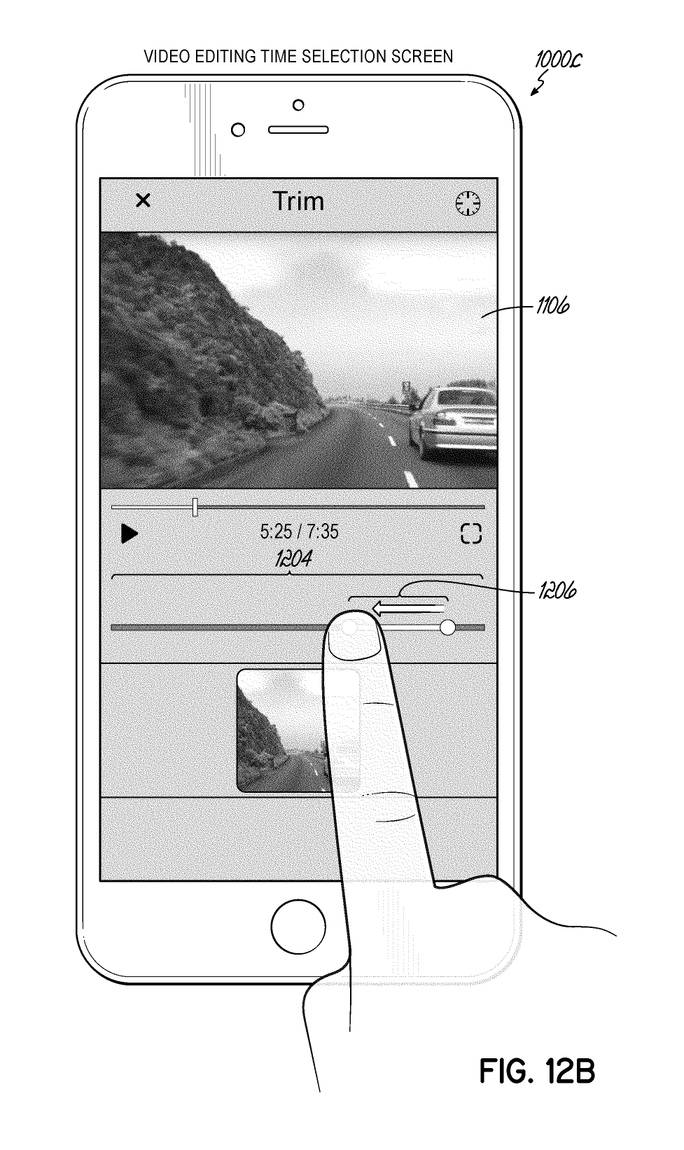

FIGS. 12A and 12B illustrate a process of editing a video clip using touch screen input in the form of a swiping motion to define a portion of a video clip. In FIG. 12A, in the video editing screen 1000b, a first portion (i.e., time interval) of a video segment has been selected when a user performs a swiping motion on the touch screen. The selected portion is indicated by a visually highlighted region 1202. According to an embodiment, the selected region may be edited in finer detail as shown in FIG. 12B. For example, the selected portion defined by the visually highlighted region 1202, shown in the video editing screen 1000b of FIG. 12A may be expanded to un-highlighted region 1204 shown in the more in-depth editing screen 1000c of FIG. 12B. Then, the selected first portion of a video segment may be edited in further detail by selecting a second portion of the video segment as indicated by a visually highlighted region 1206. According to an embodiment, this process of sequentially refining segments of video may be repeated as many times as desired.

Time-lapse view 132 provided by the viewing devices 130 via the smart-time lapse view generation 122 of the cloud server 120 refers to the visual experience of fast-forwarding a video recording, by sampling the video at a certain rate and displaying concatenated sampled frames. In the context of playing road-trip videos recorded while driving/riding/walking along a road, time-lapse view provides an interesting visual experience of sceneries passing by quickly. A challenge that arises from creating the time-lapse view is how video should be sampled for the optimal experience

The disclosed embodiments include a system and algorithms for intelligently determining variable sampling rates of original raw video, and producing a time-lapse view that provides an optimized view experience. The algorithm is based on several factors, including length of the trip covered, length of the video recorded, and such, and configurable constraints, including maximum distance covered per second, which does not cause watchers to start feeling uncomfortable, the required length of the output time-lapsed video, and requirement on visual effects, such as acceleration at the beginning and the deceleration at the end.

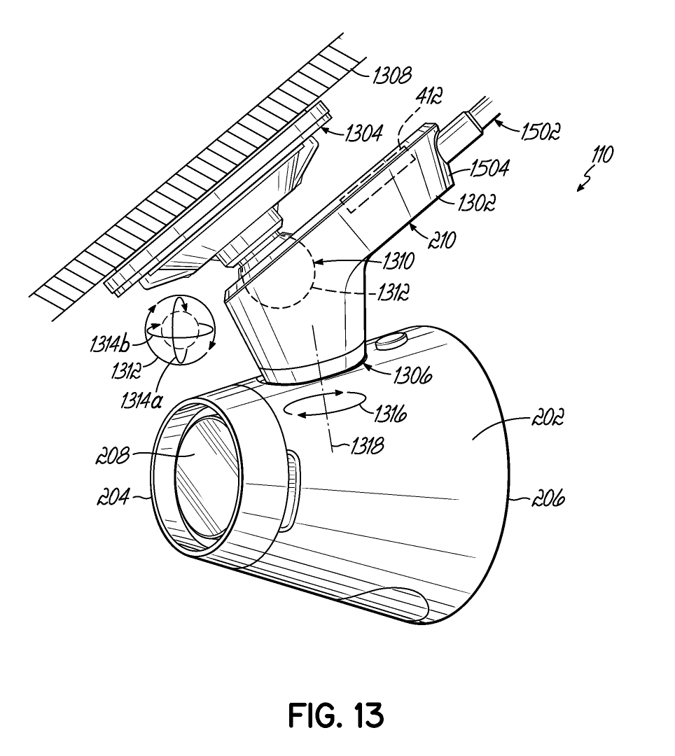

Further features of the mounting device 210 are provided in the following discussion. FIG. 13 is a schematic illustration of the portable video capture device 110 coupled to a mounting device 210. The disclosed mounting device 210 for the portable video capture device 110 includes a main body 1302, a first coupling device 1304, and a second coupling device 1306. The main body includes a Global Positioning System (GPS) receiver 412. The first coupling device 1304 provides a mechanical coupling between the main body 1302 and a mounting surface 1308 (such as an automobile windshield). The second coupling device 1306 provides an electrical and mechanical coupling between the main body 1302 and the portable video capture device 110.

The GPS receiver 412 includes a GPS antenna 520 and a GPS module 522 (e.g., see FIG. 5). As discussed above, GPS module 522 includes circuitry that receives GPS signals from the GPS antenna 520 and provides the received GPS signals to the portable video capture device 110 through the electrical coupling provided by the second coupling device 1306. As shown in FIG. 4B and FIG. 13, the GPS antenna 412 may be mounted in a region of the main body 1302 that is proximal to the mounting surface 1308. Mounting the GPS antenna 412 in this way may improve reception of GPS signals due to the proximity of the GPS antenna 412 to the mounting surface 1308. Further, as described above, the GPS antenna and GPS module may be configured to generate position information that is updated at a rate of no less than 6 Hz. For example, the position information may be updated at a rate of 10 Hz or at any other rate as dictated by available technology.

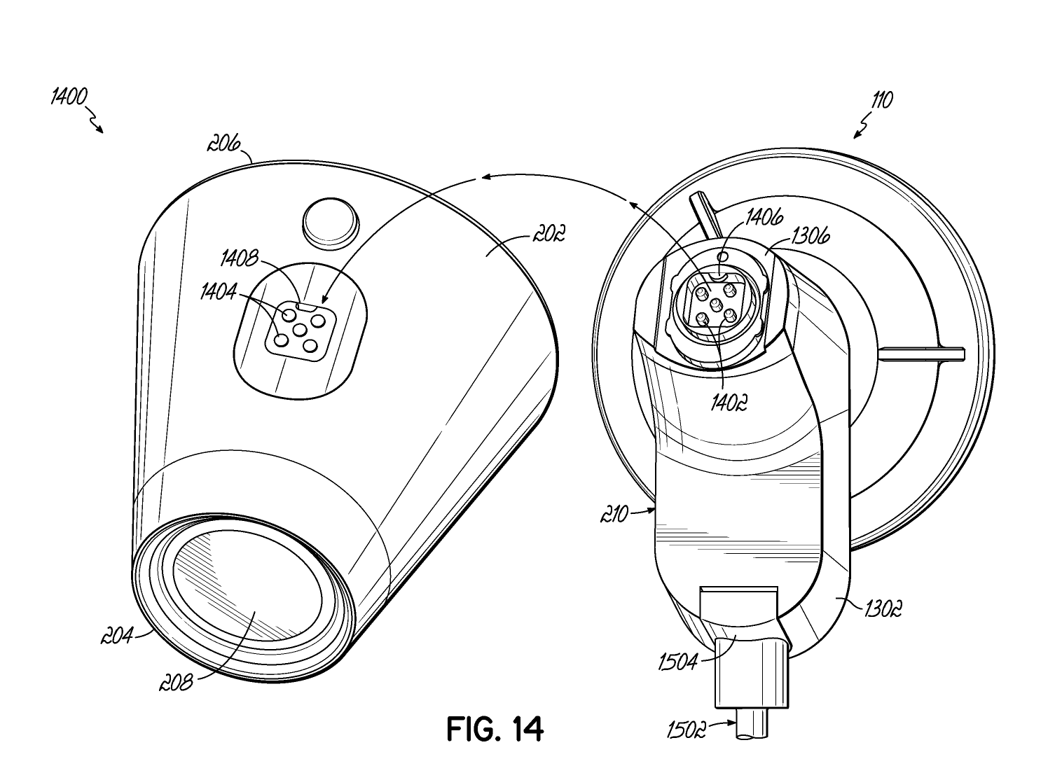

According to an embodiment, first coupling device 1304 may provide an adjustable mechanical coupling 1310 between the main body and a mounting surface allowing positioning of the main body in at least two dimensions relative to the mounting surface. For, example, the first coupling device 1304 may include a mechanical ball mechanism 1312 that enables positioning in two angular directions 1314a and 1314b. Further, the second coupling device 1306 may provide a flexible mechanical coupling between the main body 210 and the portable video capture device 110 allowing motion of the portable video capture device in at least one dimension relative to the main body. For example, the second coupling device 1306 may enable positioning in at least one angular direction 1316 about an axis 1318. The second coupling device 1306 may be configured to form a detachable electrical and mechanical coupling between the main body and the portable video capture device, as described in greater detail below with reference to FIG. 14.

According to an embodiment, the electrical coupling of the second coupling device 1306 may include a dual-purpose connector that provides both a data connection and a power connection to the portable video capture device. For example, the dual-purpose connector may a five-point connector that makes five corresponding electrical connections with the portable video capture device 110, as illustrated in FIG. 14.

FIG. 14 is a schematic illustration 1400 of the portable video capture device 110 and the mounting device 210 illustrating details of an electrical and mechanical coupling provided by the second coupling device 1306, according to an embodiment. In this example, five electrical connectors 1402 of the second coupling device 1306 mate with five corresponding connectors 1404 of the portable video capture device 110.

The dual-purpose connector may further include mechanical features 1406 that mate with corresponding mechanical features 1408 of the portable video capture device 110 to provide alignment of conducting elements 1402 of the dual-purpose connector with corresponding conducting elements 1404 of the portable video capture device to thereby generate the electrical coupling between the main body and the portable video capture device. The mechanical features 1406 and 1408 also provide stability to mechanical coupling provided by the second coupling device 1306.

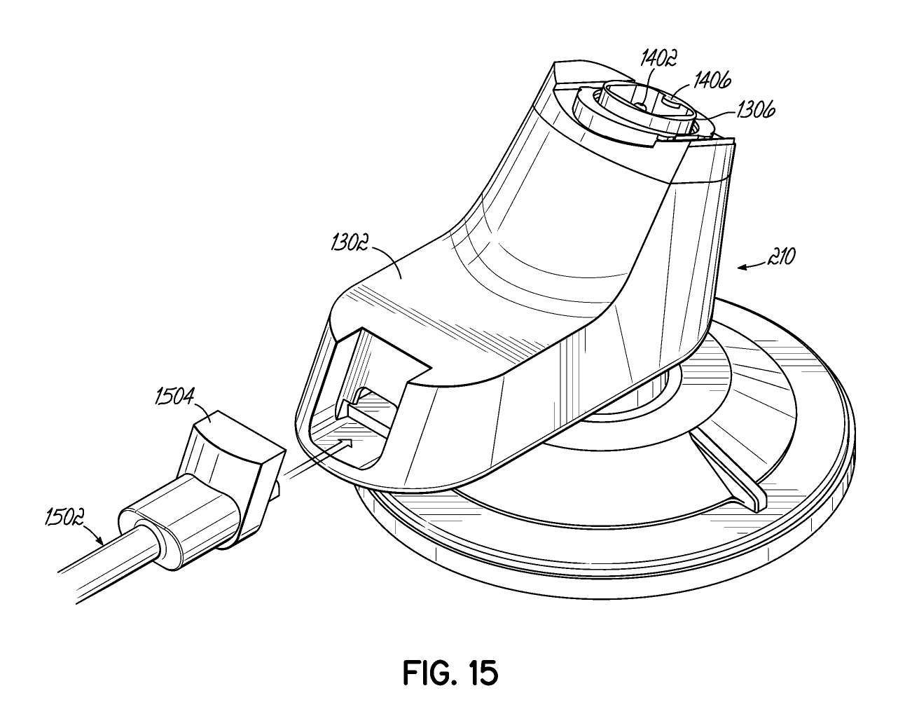

In further embodiments, the mounting device 210 may include a power source connector 1502 as illustrated in FIG. 15. FIG. 15 is a schematic illustration 1500 of the mounting device including a power source connector 1502, according to an embodiment. In this example, the power source connector 1502 connects to an external power source (not shown) and receives electrical power from the external power source. The power source connector 1502 further transmits a first portion of the received electrical power to the portable video capture device through the electrical coupling provided by the second coupling device 1306. In further examples, the power source connector 1502 may include a Universal Serial Bus (USB). In further embodiments, the power source connector 1502 may be mounted to the main body 1302 on a surface of the main body and may form a detachable connection 1504 to the main body. In further embodiments, the power source connector 1502 may provide power to the GPS receiver 412 as well as to the portable video capture device 110.

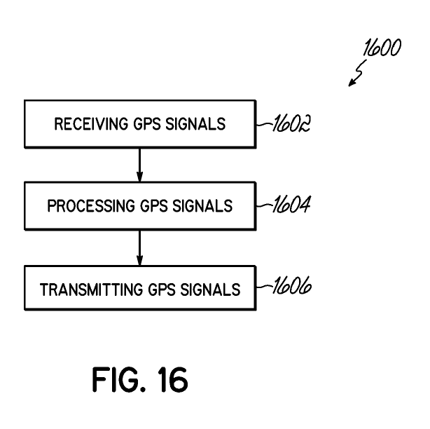

FIG. 16 is a flowchart 1600 illustrating a method of operating a mounting device 210 for a portable video capture device 110, according to an embodiment. In a first stage 1602, the method includes receiving GPS signals by the GPS antenna. In stage 1604, the method includes processing the received GPS signals by a processor circuit in the GPS module. In stage 1606, the method further includes transmitting the processed GPS signals to the portable video capture device 110 through the electrical coupling between the main body of the mounting device and the portable video capture device provided by the second coupling device 1306. The disclosed method further may further include generating, from the GPS signals, position information that is updated at a rate of no less than 6 Hz, and transmitting the position information to the portable video capture device. For example, the position information may be updated at a rate of 10 Hz or at any other rate as dictated by available technology.

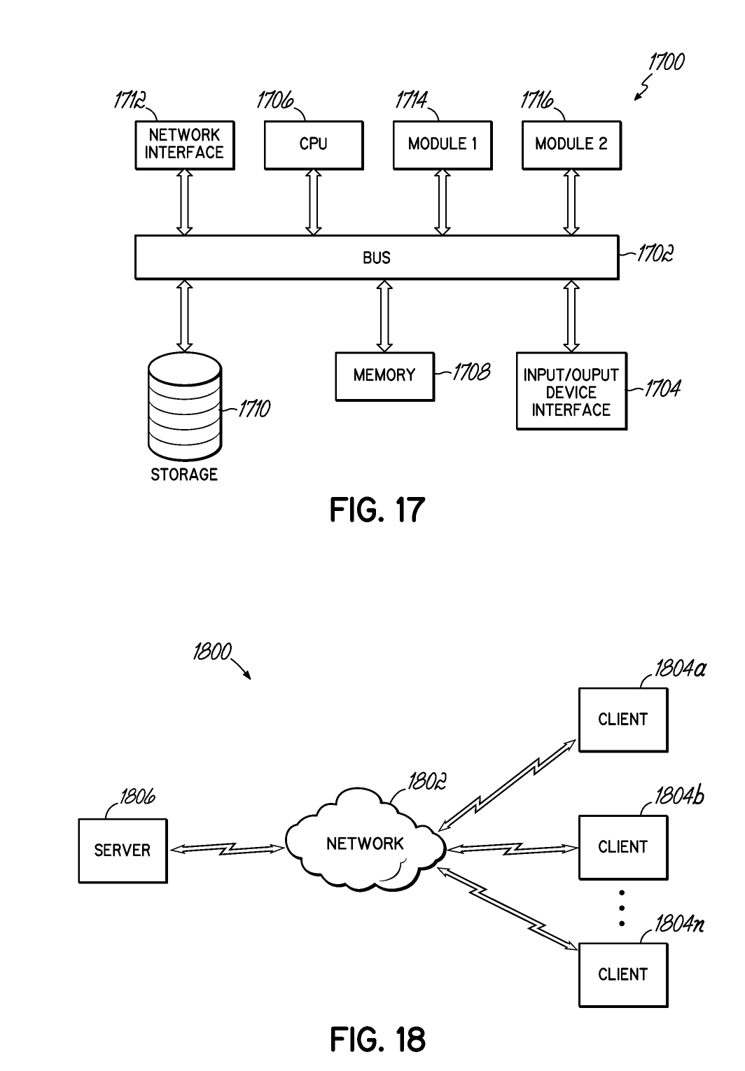

FIG. 17 is a block diagram illustrating an example computer-based system 1700 that may be used to control a camera system 100, according to an embodiment. The system 1700 comprises a bus 1702 that serves as an interconnect between the various components of the system 1700. An input/output device interface 1704 is connected to the bus 1702. The input/output device may be a keyboard, mouse, display, touch screen overlay, speakers, camera, etc.

A central processing unit (CPU) 1706 is connected to the bus 1702 and provides for the execution of computer instructions. Memory 1708 provides volatile storage for data used for carrying out computer instructions. Storage 1710 provides non-volatile storage for software instructions, such as an operating system (not shown). Memory 1708 and/or storage 1710 may be configured with program instructions implementing methods for providing portable video capture device controls detailed in FIG. 1. The system 1700 also comprises a network interface 1712, such as the Smart WiFi Connectivity interface 106 of FIG. 1 for connecting to any variety of networks known in the art, including cloud, wide area networks (WANs) and local area networks (LANs).

A first module 1714 may be connected to the bus 1702. The first module 1714 may be configured to process commands for controlling a portable video capture device 110 to capture visual data. The first module 1714 may receive control commands. For example, the first module 1714 may retrieve programmed control commands stored on the storage device 1710 or stored in memory 1708. The first module 1714 may also receive control commands from mobile devices from any point communicatively coupled to the system 1700 via the network interface 1712 and/or input/output device interface 1704.

The system 1700 further may further comprise a second module 1716 that is communicatively/operatively coupled to the first module 1714. The second module 1716 may be configured to display visual data captured by the camera sensors of the portable video capture device 110. The second module 1716 may display the captured visual data through a display device. For example, the second module 1716 may retrieve recorded captured visual data from the storage device 1710 or memory 1708. According to an embodiment, the second module 1716 may stream the captured visual data in real-time to the display 1704 by CPU 1706 via the bus 1702. The second module 1716 may also stream the visual data to any point communicatively coupled to the system 1700 via the network interface 1712.

The example embodiments described herein may be implemented in many ways. In some instances, the various methods, systems, and devices described herein may each be implemented by a physical, virtual, or hybrid general purpose computer, such as the computer system 1700 of FIG. 17. The computer system 1700 may be transformed into the machines that execute the methods described herein, for example, by loading software instructions into either memory 1708 or non-volatile storage 1710 for execution by the CPU 1706. Further, while the first module 1714 and second module 1716 are shown as separate modules, in an example embodiment these modules may be implemented using a variety of configurations.

The system 1700 and its various components may be configured to carry out any embodiments described herein. For example, the system 1700 may be configured to carry out the methods described above. In an example embodiment, the first module 1714 and second module 1716 may be implemented in software that is stored on the memory 1708 and/or storage device 1710. The system 1700 may implement the first module 1714 that controls a portable video capture device 110 that captures visual data. Further, the components of the system 1700 may implement the second module 1716 that is operatively coupled to the first module and configured to display the captured visual data.

FIG. 18 illustrates an example computer network environment 1800 in which an embodiment may be implemented. In the computer network environment 1800, the server is linked through the communications network 1802 to the clients 1804a-n. The environment 1800 may be used to allow the clients 1804a-n, alone or in combination with server 1806 to execute any of the methods described hereinabove (e.g., methods executed by the components of FIGS. 1-4). The environment 1800 may comprise the connected computer system 100 of FIG. 1. The example embodiments described above may be implemented in many ways. In some instances, the various methods and machines described herein may each be implemented by a physical, virtual, or hybrid general purpose computer, or a computer network environment such as the computer environment 1800.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically includes computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. The program code may be distributed using a computer-readable storage medium having computer-readable program instructions stored thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer.

A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general-purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for describing specific embodiments only and is not intended to be limiting of the embodiments of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes,” “having,” “has,” “with,” or variants thereof are used in either the detailed description or the claims, such terms are intended to be inclusive in a manner similar to the term “comprising.”

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A mounting device for a portable video capture device, the mounting device comprising:
a main body comprising a Global Positioning System (GPS) receiver;
a first coupling device that provides a mechanical coupling between the main body and a mounting surface; and
a second coupling device that provides an electrical and mechanical coupling between the main body and the portable video capture device.

2. The mounting device of claim 1, wherein the GPS receiver further comprises:
a GPS antenna; and
a GPS module comprising circuitry that receives GPS signals from the GPS antenna and provides the received GPS signals to the portable video capture device through the electrical coupling provided by the second coupling device.

3. The mounting device of claim 2, wherein the GPS antenna is mounted in a region of the main body that is proximal to the mounting surface.

4. The mounting device of claim 1, wherein:
the GPS receiver provides signals, to the portable video capture device, containing position information that is updated at a rate of no less than 6 Hz.

5. The mounting device of claim 1, wherein the electrical coupling of the second coupling device comprises a dual-purpose connector that provides both a data connection and a power connection to the portable video capture device.

6. The mounting device of claim 5, wherein the dual-purpose connector comprises a five-point connector that makes five corresponding electrical connections with the portable video capture device.

7. The mounting device of claim 5, wherein the dual-purpose connector comprises mechanical features that mate with corresponding mechanical features of the portable video capture device to provide alignment of conducting elements of the dual-purpose connector with corresponding conducting elements of the portable video capture device to thereby generate the electrical coupling between the main body and the portable video capture device.

8. The mounting device of claim 1, further comprising:
a power source connector that:
connects to an external power source and receives electrical power from the external power source; and
transmits a first portion of the received electrical power to the portable video capture device through the electrical coupling provided by the second coupling device.

9. The mounting device of claim 8, wherein the power source connector comprises a Universal Serial Bus (USB).

10. The mounting device of claim 8, wherein the power source connector is mounted to the main body on a surface of the main body and forms a detachable connection to the main body.

11. The mounting device of claim 8, wherein the power source connector transmits a second portion of the received power to the GPS receiver.

12. The mounting device of claim 1, wherein the second coupling device forms a detachable electrical and mechanical coupling between the main body and the portable video capture device.

13. The mounting device of claim 1, wherein the first coupling device provides an adjustable mechanical coupling between the main body and a mounting surface allowing positioning of the main body in at least two dimensions relative to the mounting surface.

14. The mounting device of claim 1, wherein the second coupling device provides a flexible mechanical coupling between the main body and the portable video capture device allowing motion of the portable video capture device in at least one dimension relative to the main body.

15. A method of operating a mounting device for a portable video capture device, the method comprising:
receiving, by a GPS antenna located in a main body of the mounting device, GPS signals;
processing, by a processor circuit in a GPS module located in the main body of the mounting device, the received GPS signals; and
transmitting, through a first coupling device that provides an electrical and mechanical coupling between the main body of the mounting device and the portable video capture device, the processed GPS signals to the portable video capture device that is mounted to the first coupling device.

16. The method of claim 15, further comprising:
processing, by the processor circuit in the GPS module, the GPS signals to generate position information that is updated at a rate of no less than 6 Hz; and
transmitting, through the first coupling device, the position information to the portable video capture device.

17. The method of claim 15, further comprising:
receiving, by a power source connector of the main body of the mounting device, electrical power from an external power source;
transmitting a first portion of the received electrical power to the GPS module located in the main body of the mounting device; and
transmitting, through the first coupling device, a second portion of the received electrical power to the portable video capture device.

18. The method of claim 15, further comprising:
mounting the main body of the mounting device to a mounting surface using a second coupling device that provides a mechanical coupling between the main body and the mounting surface.

19. A non-transitory computer readable storage device, comprising computer program instructions stored thereon that, when executed by a processor, cause the processor to control circuitry in a mounting device for a portable video capture device by performing the following operations:
receiving, by a GPS antenna located in a main body of a mounting device, GPS signals;
processing, by a processor circuit in a GPS module located in the main body of the mounting device, the received GPS signals; and
transmitting, through a first coupling device that provides an electrical and mechanical coupling between the main body of the mounting device and the portable video capture device, the processed GPS signals to the portable video capture device that is mounted to the first coupling device.

20. The non-transitory computer readable storage device of claim 19, further comprising computer program instructions stored thereon that, when executed by a processor, cause the processor to control the mounting device for the portable video capture device by performing the following operations:
processing, by the processor circuit of the GPS module, the GPS signals to generate position information that is updated at a rate of no less than 6 Hz; and
transmitting, through the first coupling device, the position information to the portable video capture device.
